(19) United States
(12) Patent Application Publication
(10) Pub. No.: US 2022/0266709 A1
(43) Pub. Date: Aug. 25, 2022

(54) MOVING BODY, BATTERY CONTROL METHOD, AND NON-TRANSITORY COMPUTER-READABLE MEDIUM

(71) Applicant: PANASONIC INTELLECTUAL PROPERTY MANAGEMENT CO., LTD., Osaka (JP)

(72) Inventors: Makoto HINATA, Kanagawa (JP); Masahiro ANEZAKI, Kanagawa (JP); Takanao YANO, Kanagawa (JP); Tsuyoshi NISHIO, Chiba (JP)

(73) Assignee: PANASONIC INTELLECTUAL PROPERTY MANAGEMENT CO., LTD., Osaka (JP)

(21) Appl. No.: 17/742,932

(22) Filed: May 12, 2022

Related U.S. Application Data
(63) Continuation of application No. PCT/JP2020/038811, filed on Oct. 14, 2020.

(30) Foreign Application Priority Data
Nov. 15, 2019 (JP) 2019-206879
Nov. 15, 2019 (JP) 2019-206880
Nov. 15, 2019 (JP) 2019-206881

(51) Int. Cl. B60L 53/53; B60L 58/18; B60L 50/60; B60S 9/02; B62D 63/02; B60L 50/53

(52) U.S. Cl. CPC B60L 53/53; B60L 58/18; B60L 50/66; B60S 9/02; B62D 63/025; B60L 50/53; B60L 2200/18; B60L 2200/36; B60L 2200/46; B60L 2250/16

(57) ABSTRACT

A moving body includes: a first body including at least one wheel, an electric motor and a first secondary battery; and a second body attachable to and detachable from the first body and including an electric power load and a second secondary battery. When the second body is mounted on the first body, at least one of the second secondary battery and the first secondary battery is allowed to be charged in a charging mode including at least one of a first charging mode and a second charging mode. In the first charging mode, the second secondary battery is charged using electric power output from the first secondary battery. In the second charging mode, the first secondary battery is charged using electric power output from the second secondary battery.

### CROSS-REFERENCE TO RELATED APPLICATIONS

This is a continuation of International Application No. PCT/JP2020/038811 filed on Oct. 14, 2020, and claims priority from Japanese Patent Application No. 2019-206879 filed on Nov. 15, 2019, Japanese Patent Application No. 2019-206880 filed on Nov. 15, 2019, and Japanese Patent Application No. 2019-206881 filed on Nov. 15, 2019, the entire content of which is incorporated herein by reference.

### TECHNICAL FIELD

The present disclosure relates to a moving body that is movable using wheels.

### BACKGROUND ART

In recent years, research and development of autonomous driving vehicles have been actively conducted all over the world. Some autonomous driving vehicles have a separation structure including a carriage and a cabin (see, for example, U.S. Pat. No. 10,124,688). The autonomous driving vehicle described in U.S. Pat. No. 10,124,688 travels with a battery, and when a battery capacity becomes insufficient, the carriage is replaced with another carriage on which a charged battery is mounted. At this time, it is planned where the replacement with the other carriage is to be performed. In the following description, the autonomous driving vehicle is referred to as “vehicle”, the carriage is referred to as “self-propelled carriage unit”, and the cabin is referred to as “cabin unit”.

### SUMMARY OF INVENTION

However, in the autonomous driving vehicle described in U.S. Pat. No. 10,124,688 described above, when the battery capacity for going to a destination is insufficient, it is necessary to replace the carriage with the other carriage on the way, and it takes time to perform the replacement work. Further, a replacement point does not necessarily exist on an optimal route, and in a case where the replacement point does not exist on the optimal route, the replacement is performed on a route in which a detour occurs, and therefore a useless time is spent.

An object of the present disclosure is to provide a moving body that can maximize a traveling distance of a self-propelled carriage unit and control an optimal charging timing.

The present disclosure provides a moving body including: a first body including at least one wheel, the first body being configured to travel by the wheel; and a second body attachable to and detachable from the first body, wherein the first body includes an electric motor configured to drive the at least one wheel and a first secondary battery that allows first electric power to be supplied to the electric motor, wherein the second body includes a predetermined electric power load and a second secondary battery that allows second electric power to be supplied to the predetermined electric power load, and wherein when the second body is mounted on the first body, at least one of the second secondary battery and the first secondary battery is allowed to be charged in a charging mode including at least one of a first charging mode and a second charging mode, wherein in the first charging mode, the second secondary battery is charged using third electric power output from the first secondary battery, and wherein in the second charging mode, the first secondary battery is charged using fourth electric power output from the second secondary battery.

The present disclosure provides a battery control method for a moving body, the moving body including: a first body including at least one wheel, the first body being configured to travel by the wheel; and a second body attachable to and detachable from the first body, wherein the first body includes an electric motor configured to drive the at least one wheel and a first secondary battery that allows first electric power to be supplied to the electric motor, wherein the second body includes a predetermined electric power load and a second secondary battery that allows second electric power to be supplied to the predetermined electric power load, the battery control method including: charging at least one of the second secondary battery and the first secondary battery in a charging mode when the second body is mounted on the first body, the charging mode including at least one of a first charging mode and a second charging mode, wherein in the first charging mode, the second secondary battery is charged using third electric power output from the first secondary battery, and wherein in the second charging mode, the first secondary battery is charged using fourth electric power output from the second secondary battery.

The present disclosure provides a non-transitory computer-readable medium storing instructions that, when executed by one or more processor, cause a computer to perform operations for a moving body, the moving body including: a first body including at least one wheel, the first body being configured to travel by the wheel; and a second body attachable to and detachable from the first body, wherein the first body includes an electric motor configured to drive the at least one wheel and a first secondary battery that allows first electric power to be supplied to the electric motor, wherein the second body includes a predetermined electric power load and a second secondary battery that allows second electric power to be supplied to the predetermined electric power load, the operations including: charging at least one of the second secondary battery and the first secondary battery in a charging mode when the second body is mounted on the first body, the charging mode including at least one of a first charging mode and a second charging mode, wherein in the first charging mode, the second secondary battery is charged using third electric power output from the first secondary battery, and wherein in the second charging mode, the first secondary battery is charged using fourth electric power output from the second secondary battery.

### BRIEF DESCRIPTION OF DRAWINGS

FIG. 1 is a block diagram showing a schematic configuration of a moving body management system of a first embodiment.

FIG. 2 is a perspective view showing an external appearance of a vehicle in the moving body management system of the first embodiment.

FIG. 3 is a perspective view showing a state where a cabin unit of the vehicle is placed on ground in the moving body management system of the first embodiment.

FIG. 4 is a perspective view showing a state where the cabin unit of the vehicle is made to stand by itself by leg portions in the moving body management system of the first embodiment.

FIG. 5 is a perspective view showing a state where the cabin unit of a passenger type of the vehicle is made to stand by itself by the leg portions in the moving body management system of the first embodiment.

FIG. 6 is a perspective view showing an external appearance of a vending machine type of the vehicle in the moving body management system of the first embodiment.

FIG. 7 is a perspective view showing a state where the cabin unit is lowered from the self-propelled carriage unit and placed on the ground in the moving body management system of the first embodiment.

FIG. 8 is a perspective view showing the cabin unit of a sales type in the moving body management system of the first embodiment.

FIG. 9 is a perspective view showing the cabin unit of a publicity type in the moving body management system of the first embodiment.

FIG. 10 is a perspective view showing the cabin unit of a food and drink type in the moving body management system of the first embodiment.

FIG. 11 is a perspective view showing the cabin unit of a rest type in the moving body management system of the first embodiment.

FIG. 12 is a perspective view showing the cabin unit of an accommodation type in the moving body management system of the first embodiment.

FIG. 13 is a perspective view showing the cabin unit of a shower/bathroom type in the moving body management system of the first embodiment.

FIG. 14 is a perspective view showing the cabin unit of an event type in the moving body management system of the first embodiment.

FIG. 15 is a perspective view showing the cabin unit of a leisure type in the moving body management system of the first embodiment.

FIG. 16 is a perspective view showing a state where a battery of the cabin unit is charged by an external power supply in the moving body management system of the first embodiment.

FIG. 17 is a flowchart for illustrating an operation of the vehicle in the moving body management system of the first embodiment.

FIG. 18 is a block diagram showing a schematic configuration of a moving body management system of a second embodiment.

FIG. 19 is a table showing an example of cabin unit mounting information held by a cabin side ECU of a cabin unit in the moving body management system of the second embodiment.

FIG. 20 is a block diagram showing a schematic configuration of an autonomous driving ECU of a self-propelled carriage unit in the moving body management system of the second embodiment.

FIG. 21 is a flowchart for illustrating an operation of the autonomous driving ECU of the self-propelled carriage unit in the moving body management system of the second embodiment.

FIG. 22 is a flowchart for illustrating an operation of the autonomous driving ECU when there is a limitation to a vehicle height of a vehicle in the moving body management system of the second embodiment.

FIGS. 23A and 23B are diagrams showing vehicle heights of the vehicle in the moving body management system of the second embodiment.

FIG. 24 is a diagram showing a case where there are three traveling route candidates in the moving body management system of the second embodiment.

FIG. 25 is a flowchart for illustrating an operation of the autonomous driving ECU when there is a braking limit on a downhill in the moving body management system of the second embodiment.

FIG. 26 is a diagram showing a relationship between a hill-climbable angle and a brake braking force of the vehicle in the moving body management system of the second embodiment.

FIG. 27 is a diagram showing a case where there are three traveling route candidates in the moving body management system of the second embodiment.

FIG. 28 is a flowchart for illustrating an operation of the autonomous driving ECU when a distance and a timing at which a braking force is applied to stop braking in the vehicle are controlled with cabin unit mounting information in the moving body management system of the second embodiment.

FIGS. 29A and 29B are diagrams showing an example of a braking distance change in accordance with an acceleration level in the moving body management system of the second embodiment.

FIG. 30 is a diagram showing an example of a time until a target speed is reached due to a difference in the acceleration level in the moving body management system of the second embodiment.

FIG. 31 is a flowchart for illustrating turning speed control of the autonomous driving ECU of the self-propelled carriage unit in the moving body management system of the second embodiment.

FIGS. 32A and 32B are explanatory diagrams for obtaining a turning speed of the vehicle in the moving body management system of the second embodiment.

FIG. 33 is a side view showing an external appearance of a vehicle of a moving body management system of a third embodiment.

FIG. 34 is a side view showing an external appearance of a modified example [1] of a self-propelled carriage unit of the vehicle in the moving body management system of the third embodiment.

FIG. 35 is a side view showing an external appearance of a modified example [2] of a self-propelled carriage unit of the vehicle in the moving body management system of the third embodiment.

FIG. 36 is a side view showing a state where protruding parts of the self-propelled carriage unit are folded in the moving body management system of the third embodiment.

FIG. 37 is a side view showing an external appearance of a modified example [1] of a cabin unit of the vehicle in the moving body management system of the third embodiment.

FIG. 38 is a side view showing an external appearance of a modified example [2] of a cabin unit of the vehicle in the moving body management system of the third embodiment.

FIG. 39 is a block diagram showing an electrical configuration of the self-propelled carriage unit of the vehicle in the moving body management system of the third embodiment.

FIG. 40 is a block diagram showing an electrical configuration of each of a self-propelled carriage unit and a cabin unit in the moving body management system of the third embodiment.

FIG. 41 is a flowchart for illustrating an operation of the self-propelled carriage unit of the vehicle in the moving body management system of the third embodiment.

FIG. 42 is a flowchart for illustrating an operation of the cabin unit of the vehicle in the moving body management system of the third embodiment.

FIG. 43 is a flowchart for illustrating an operation of an autonomous driving device as a monitoring system in the moving body management system of the third embodiment.

FIG. 44 is a block diagram showing an electrical configuration of each of a self-propelled carriage unit and the cabin unit in the moving body management system of the third embodiment.

FIG. 45 is a flowchart for illustrating an operation of the self-propelled carriage unit of the vehicle in the moving body management system of the third embodiment.

FIG. 46 is a flowchart for illustrating an operation of the cabin unit of the vehicle in the moving body management system of the third embodiment.

### DESCRIPTION OF EMBODIMENTS

Hereinafter, an embodiment specifically disclosing a moving body management system according to the present disclosure (hereinafter, referred to as “the present embodiment”) will be described in detail with reference to the drawings as appropriate. However, unnecessarily detailed description may be omitted. For example, detailed description of well-known matters and redundant description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims.

Hereinafter, preferred present embodiments for carrying out the present disclosure will be described in detail with reference to the drawings.

### First Embodiment

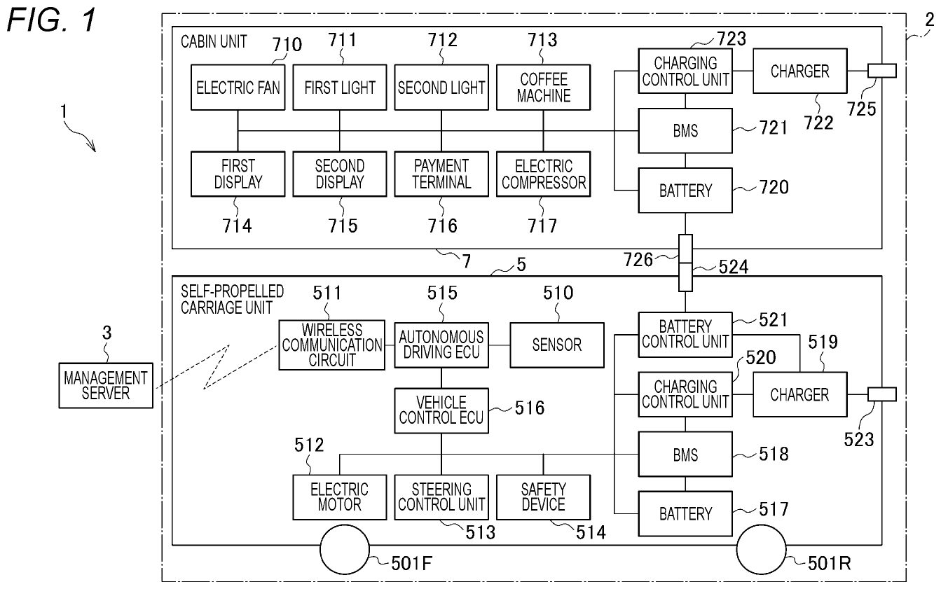

Hereinafter, a moving body management system of a first embodiment will be described with reference to the drawings. FIG. 1 is a block diagram showing a schematic configuration of a moving body management system 1 of the first embodiment. In FIG. 1, the moving body management system 1 of the first embodiment includes a vehicle 2 and a management server 3. The vehicle 2 is a moving body that autonomously operates. The management server 3 manages operation of the vehicle 2.

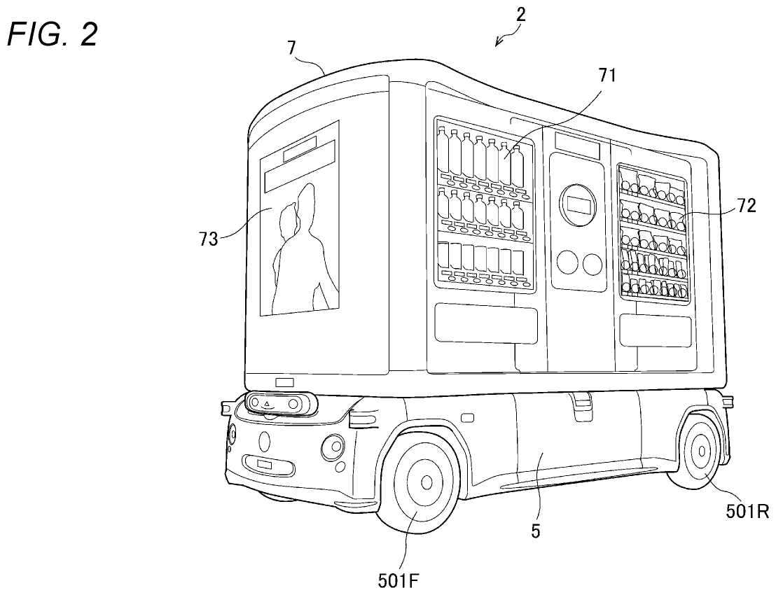

FIG. 2 is a perspective view showing an external appearance of the vehicle 2. As shown in FIG. 2, the vehicle 2 includes a self-propelled carriage unit (corresponding to a “first body”) 5 and a cabin unit (corresponding to a “second body”) 7 supported by the self-propelled carriage unit 5. The self-propelled carriage unit 5 includes two front wheels 501F (only one of the two front wheels 501F is shown in FIG. 1) and two rear wheels 501R (only one of the two rear wheels 501R is shown in FIG. 1), and travels by the two front wheels 501F and the two rear wheels 501R. The two front wheels 501F are steered wheels, and the rear wheels 501R are driven wheels. Incidentally, the front wheel is a wheel on a front side when a vehicle travels forward, and the rear wheel is a wheel on a side opposite to the front wheel. The two driven wheels 501R are driven by an electric motor 512 described later.

Instead of using the front wheels 501F as the steered wheels and the rear wheels 501R as the driven wheels, the steered wheels may also serve as the driven wheels (a drive system referred to as so-called front-engine front-drive (FF)). Further, the self-propelled carriage unit 5 is a four-wheeled vehicle including the four wheels 501F and 501R, but may be a single-wheeled vehicle including one wheel. That is, at least one wheel may be provided.

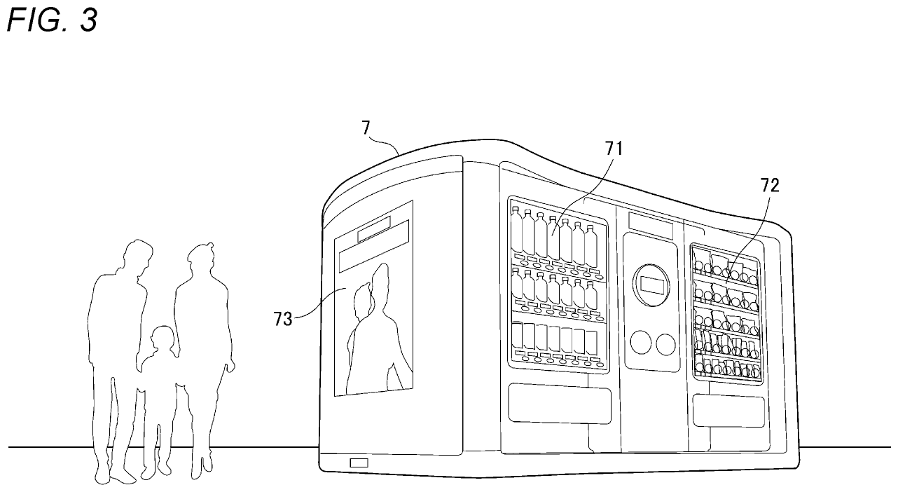

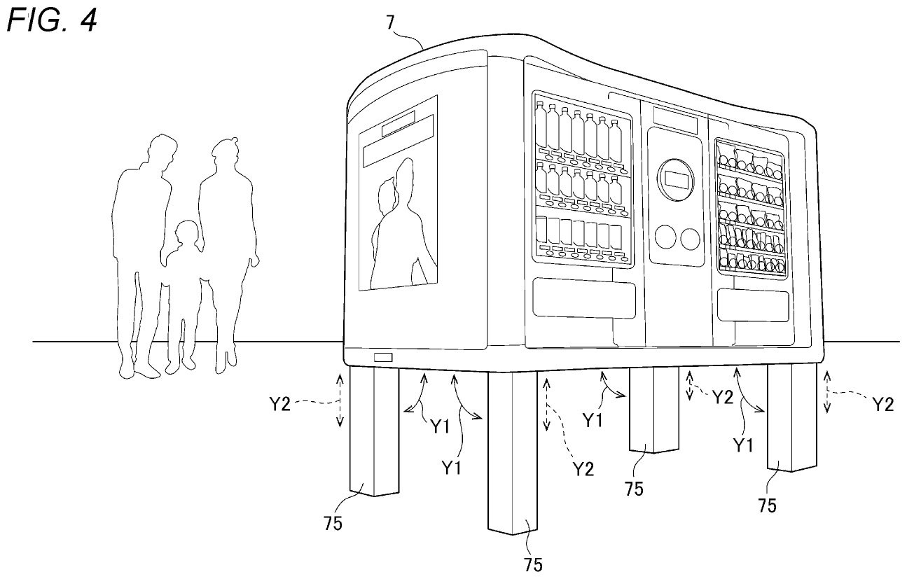

In contrast, the cabin unit 7 does not include wheels, is attachable to and detachable from the self-propelled carriage unit 5, and is mounted on the self-propelled carriage unit 5 to move. The cabin unit 7 is placed on ground or stands by itself at a leg portion by being detached from the self-propelled carriage unit 5. The leg portion of the cabin unit 7 has a foldable structure or a collapsible structure, and is in a state of being placed on the ground by being in a folded state or a collapsed state to a minimum. FIG. 3 is a perspective view showing a state where the cabin unit 7 is directly placed on the ground. Further, FIG. 4 is a perspective view showing a state where the cabin unit 7 is made to stand by itself by extending leg portions 75 in a vertical direction. In FIG. 4, the leg portion 75 can be folded in a direction indicated by an arrow Y1. When including the collapsible structure, the leg portion 75 can be extended and collapsed in a direction indicated by an arrow Y2.

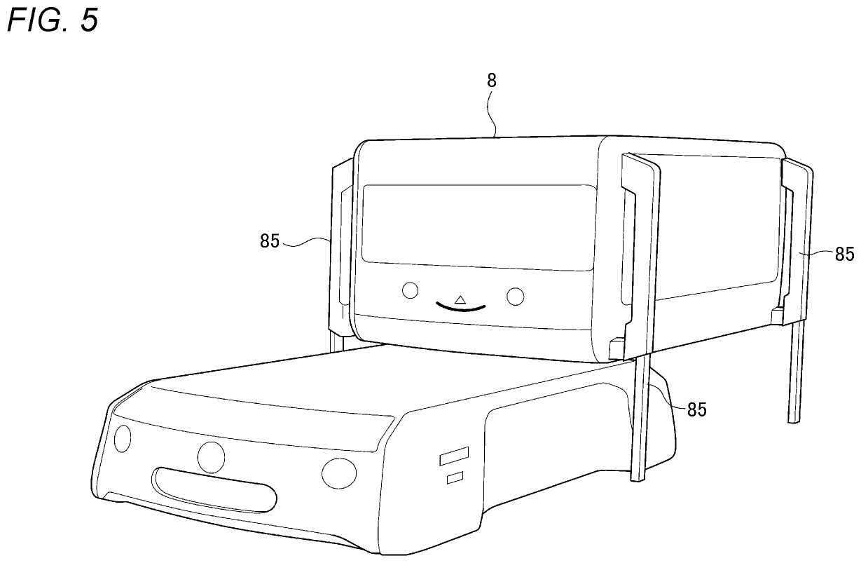

The cabin unit 7 shown in FIGS. 3 and 4 is of a vending machine type capable of vending food and drink, but the cabin unit 7 is provided with the same leg portions even in a passenger type in which a person rides. FIG. 5 is a perspective view showing a state where a cabin unit 8 of the passenger type is made to stand by itself by a leg portion. As shown in FIG. 5, the cabin unit 8 of the passenger type also includes four leg portions 85, and stands by itself by these leg portions 85.

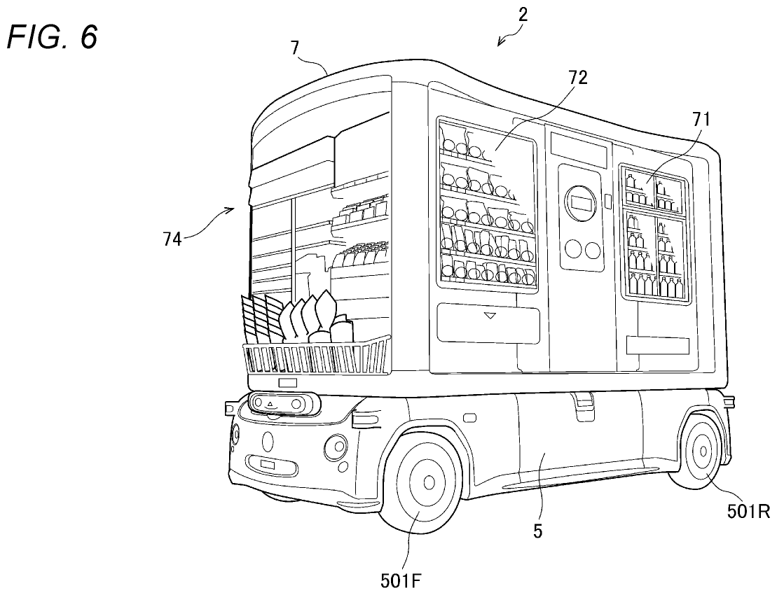

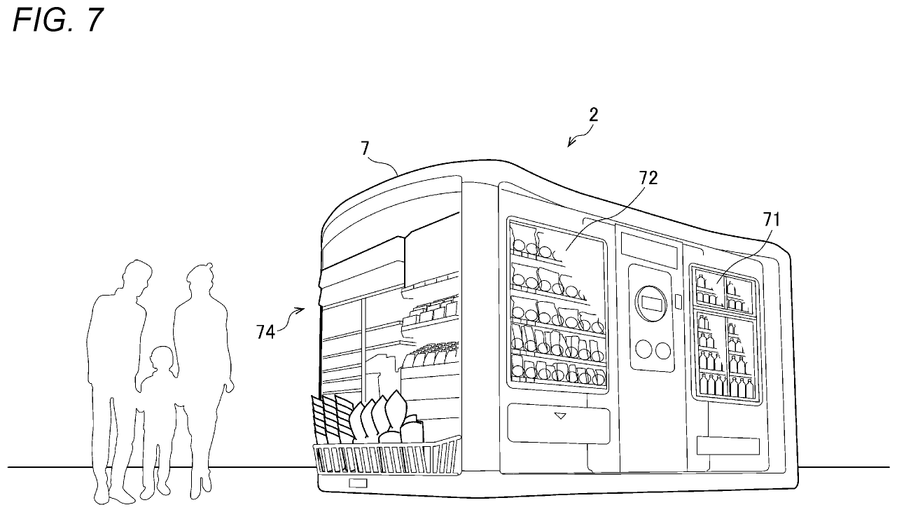

In the cabin unit 7 of the vending machine type shown in FIG. 3, drinking water 71 and snacks 72 can be vended. Further, the cabin unit 7 of the vending machine type may be provided with signage (digital signage) 73 for advertisement or publicity. Further, as shown in FIG. 6, in addition to the drinking water 71 and the snacks 72, magazines 74 such as newspapers and weekly magazines can be handled in the cabin unit 7 of the vending machine type. FIG. 7 is a perspective view showing a state where the cabin unit 7 of the vending machine type is lowered from the self-propelled carriage unit 5 and is directly placed on the ground.

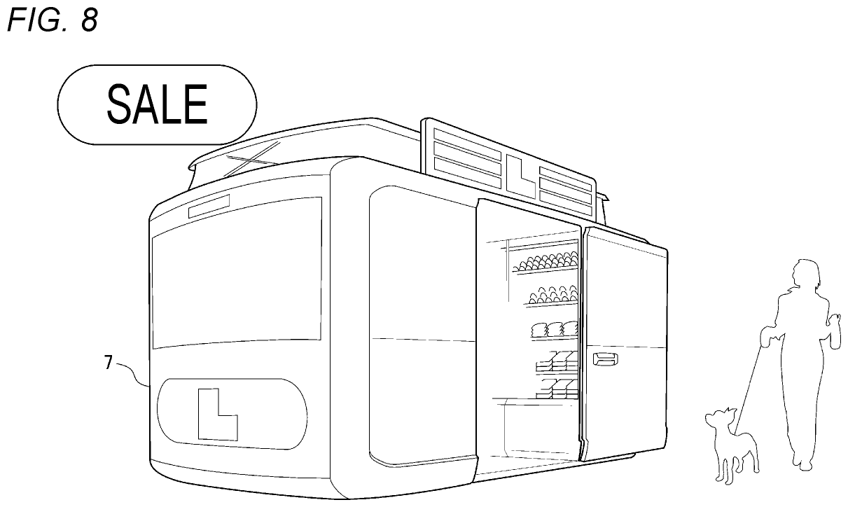

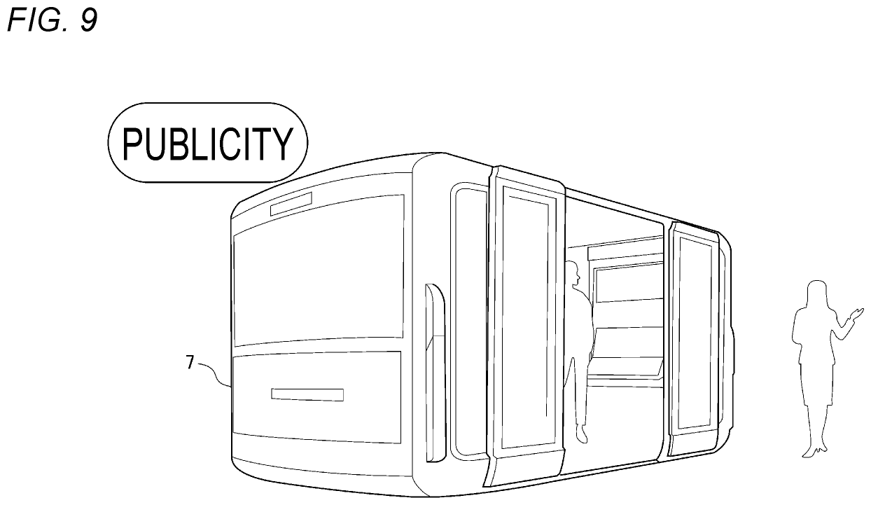

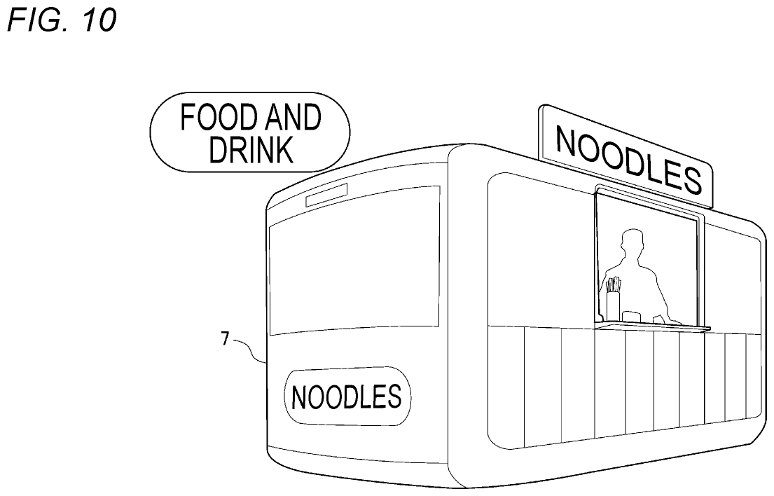

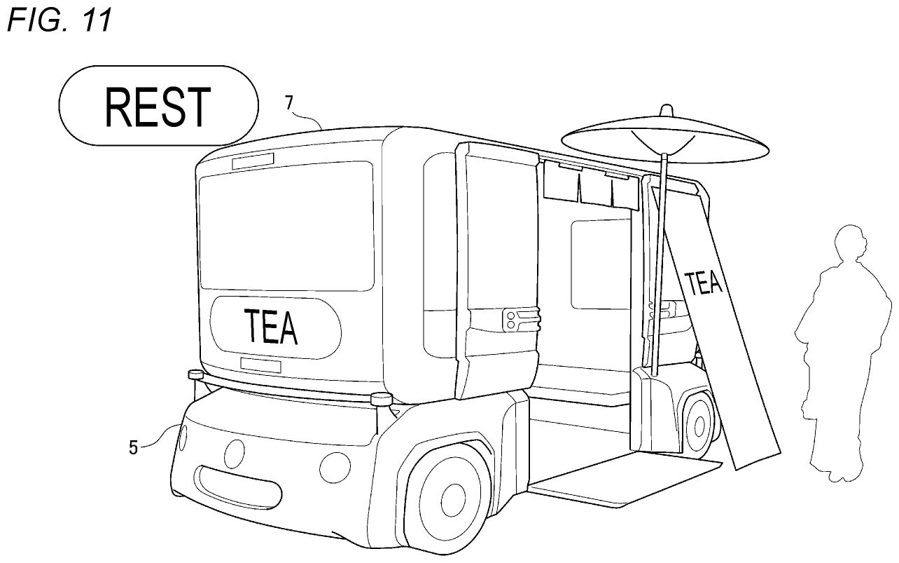

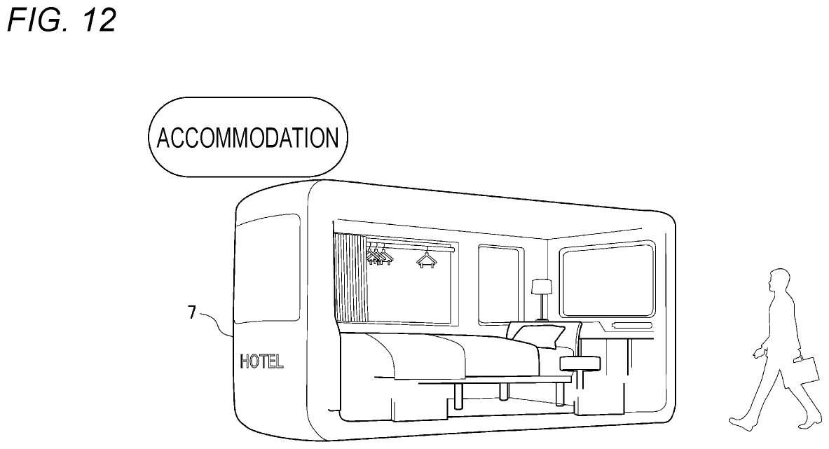

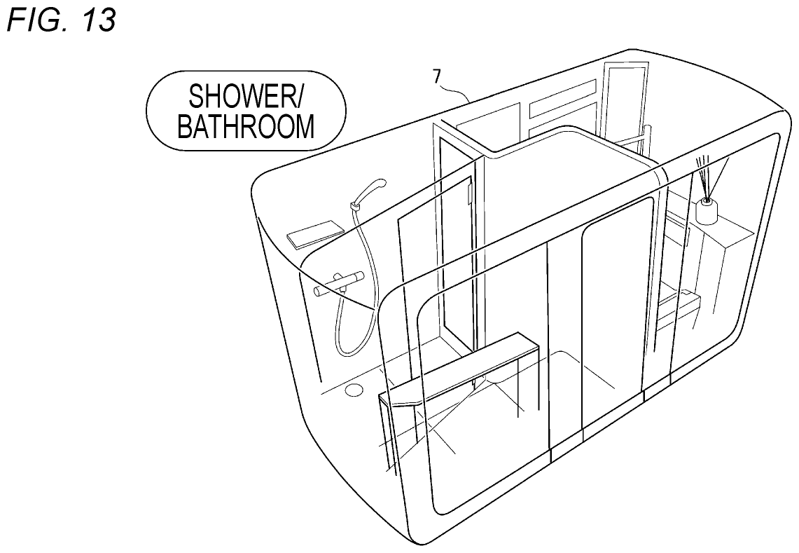

The cabin unit 7 may be of a store type in addition to the vending machine type. In the cabin unit 7 of the store type, it is possible to provide rice balls, box lunches, confectionery, drinking water, miscellaneous goods, and the like, to provide coffee, to provide a microwave oven, and the like. Other using modes of the cabin unit 7 are shown in FIGS. 8 to 15. FIG. 8 is a perspective view showing the cabin unit 7 of the store type (sales type). FIG. 9 is a perspective view showing the cabin unit 7 of a publicity type. FIG. 10 is a perspective view showing the cabin unit 7 of a food and drink type. FIG. 11 is a perspective view showing the cabin unit 7 of a rest type. FIG. 12 is a perspective view showing the cabin unit 7 of an accommodation type. FIG. 13 is a perspective view showing the cabin unit 7 of a shower/bathroom type. FIG. 14 is a perspective view showing the cabin unit 7 of an event type. FIG. 15 is a perspective view showing the cabin unit 7 of a leisure type. The cabin unit 7 of the rest type shown in FIG. 11, the cabin unit 7 of the event type shown in FIG. 14, and the cabin unit 7 of the leisure type shown in FIG. 15 are used in a state of being mounted on the self-propelled carriage unit 5.

In this way, there are various using modes of the cabin unit 7, but batteries 720 (see FIG. 1) are mounted on all types. The battery 720 mounted on the cabin unit 7 is mainly used as an electric power source for cooling drinking water, boiling water, lighting an illumination, making a sound, causing a shower to flow, and the like, and is also used for charging a battery 517 of the self-propelled carriage unit 5.

Next, configurations and operations of the self-propelled carriage unit 5 and the cabin unit 7 will be described.

In FIG. 1, the self-propelled carriage unit 5 includes a sensor 510, a wireless communication circuit 511, the electric motor 512, a steering control unit 513, a safety device 514, an autonomous driving ECU (electronic control unit) 515, a vehicle control ECU (electronic control unit) 516, the battery (corresponding to a “first secondary battery”) 517, a battery management system (BMS) 518, a charger 519, a charging control unit 520, a battery control unit 521, and charging connectors 523 and 524. The sensor 510 is directed to an outside of the self-propelled carriage unit 5 of the vehicle 2, is disposed on an end portion in a predetermined traveling direction, and is used to monitor a front side in the predetermined traveling direction. For example, a camera or a Lidar (Lidar: light detection and ranging) is used for the sensor 510. Information from the sensor 510 is taken into the autonomous driving ECU 515.

The wireless communication circuit 511 performs wireless communication with the management server 3, and receives an instruction related to battery charging (corresponding to an external instruction). A dedicated frequency band, a frequency band of moving body communication, or the like is used for the wireless communication by the wireless communication circuit 511. The wireless communication circuit 511 outputs the received information on the battery charging to the autonomous driving ECU 515. The electric motor 512 provides a drive force to the two driven wheels 501R of the self-propelled carriage unit 5. Electric power (first electric power) output from the battery 517 is supplied to the electric motor 512. Electric power (fourth electric power) output from the battery 720 of the cabin unit 7 is also supplied to the electric motor 512. The steering control unit 513 performs control to change a wheel angle of the two steered wheels 501F of the self-propelled carriage unit 5. The wheel angle refers to an angle of a wheel with respect to a direction of the wheel when the self-propelled carriage unit 5 travels straight, and may be generally referred to as a tire angle. The safety device 514 is a component for ensuring safety, such as a light and a direction indicator.

The autonomous driving ECU 515 generates information for the self-propelled carriage unit 5 to autonomously travel by using the information from the sensor 510, and outputs the generated information to the vehicle control ECU 516. Further, when receiving the instruction related to the battery charging from the management server 3, the autonomous driving ECU 515 outputs the instruction to the vehicle control ECU 516. The vehicle control ECU 516 controls the electric motor 512, the steering control unit 513, and the safety device 514 in accordance with information for autonomous traveling from the autonomous driving ECU 515. Further, when the instruction related to the battery charging is output from the autonomous driving ECU 515, the vehicle control ECU 516 controls the battery control unit 521 in accordance with the instruction. The autonomous driving ECU 515 includes a central processing unit (CPU), a read only memory (ROM) in which a program for controlling the CPU is stored, and a random access memory (RAM) used for an operation of the CPU (not shown). Details of battery control by the vehicle control ECU 516 will be described later. The vehicle control ECU 516 includes a CPU, a ROM that stores a program for controlling the CPU, and a RAM used for an operation of the CPU (not shown).

The battery 517 supplies electric power not only to the electric motor 512 of the self-propelled carriage unit 5 but also to units of the self-propelled carriage unit 5. Further, the battery 517 is also used to charge the battery 720 of the cabin unit 7. The BMS 518 detects a total voltage, a remaining capacity, and the like of the battery 517 in real time, warns an input and output current and an overcurrent, and controls a dedicated charger. The charger 519 charges the battery 517 with electric power supplied from an external power supply (not shown). When the battery 517 is charged by the external power supply, a cable (not shown) of the external power supply is connected to the charging connector 523. The charging control unit 520 is controlled by the battery control unit 521, and controls charging of the battery 517 such that the battery 517 is not overcharged.

When the cabin unit 7 is mounted on the self-propelled carriage unit 5 and the charging connector 524 of the self-propelled carriage unit 5 is connected to the charging connector 726 of the cabin unit 7, the battery control unit 521 charges the battery 720 of the cabin unit 7 based on electric power (third electric power) output from the battery 517 of the self-propelled carriage unit 5 (an example of a first charging mode), and charges the battery 517 of the self-propelled carriage unit 5 based on electric power (fourth electric power) output from the battery 720 of the cabin unit 7 (an example of a second charging mode). In this case, when the instruction from the management server 3 is to charge the battery 720 of the cabin unit 7, a signal based on the instruction is given from the vehicle control ECU 516 to the battery control unit 521, and when the instruction from the management server 3 is to charge the battery 517 of the self-propelled carriage unit 5, a signal based on the instruction is given from the vehicle control ECU 516 to the battery control unit 521.

In this way, when the instruction from the management server 3 is to charge the battery 720 of the cabin unit 7, the battery control unit 521 charges the battery 720 of the cabin unit 7 based on the electric power (third electric power) output from the battery 517 of the self-propelled carriage unit 5, and when the instruction from the management server 3 is to charge the battery 517 of the self-propelled carriage unit 5, the battery control unit 521 charges the battery 517 of the self-propelled carriage unit 5 based on the electric power (fourth electric power) output from the battery 720 of the cabin unit 7. As described above, the battery charging is performed when the battery 517 of the self-propelled carriage unit 5 charges the battery 720 of the cabin unit 7, and when the battery 720 of the cabin unit 7 charges the battery 517 of the self-propelled carriage unit 5. In addition to enabling both, it may be possible to enable only one of them.

When the battery charging is performed between the self-propelled carriage unit 5 and the cabin unit 7, the battery control unit 521 stops an operation of the charger 519 so as not to receive electric power from the external power supply.

In FIG. 1, the cabin unit 7 includes an electric fan 710, a first light 711, a second light 712, a coffee machine 713, a first display 714, a second display 715, a payment terminal 716, an electric compressor 717, the battery 720, a BMS 721, a charger 722, a charging control unit 723, and charging connectors 725 and 726. The electric fan 710 is used for air conditioning in the cabin unit 7. The first light 711 is used as an outdoor light of the cabin unit 7. The first light 711 illuminates, for example, an outer wall of the cabin unit 7. The second light 712 is used as an interior light of the cabin unit 7. The coffee machine 713 includes an electrical heat source, and boils water by the heat source to extract coffee.

The first display 714 is used as signage in the vehicle when the cabin unit 7 is, for example, a store. The second display 715 is used as signage outside the vehicle when the cabin unit 7 is, for example, a store. A large-sized liquid crystal display, an organic electro luminescence (EL) display, or the like is used as the first display 714 and the second display 715. The payment terminal 716 is used for payment of sale and purchase of a commodity when the cabin unit 7 is, for example, a store. The electric compressor 717 is used for cooling and heating or refrigerating showcases in the cabin unit 7. The electric fan 710, the first light 711, the second light 712, the coffee machine 713, the first display 714, the second display 715, the payment terminal 716, and the electric compressor 717 correspond to a predetermined electric power load.

The battery 720 supplies electric power to various electric devices (the electric fan 710, the first light 711, and the like described above) of the cabin unit 7. Further, the battery 720 is also used to charge the battery 517 of the self-propelled carriage unit 5 when the cabin unit 7 is mounted on the self-propelled carriage unit 5. Further, the battery 720 is also used as electric power for causing the electric motor 512 of the self-propelled carriage unit 5 to operate when the cabin unit 7 is mounted on the self-propelled carriage unit 5. The electric motor 512 drives the two driven wheels 501R based on the electric power (first electric power) output from the battery 517 of the self-propelled carriage unit 5 and the electric power (fourth electric power) output from the battery 720 of the cabin unit 7.

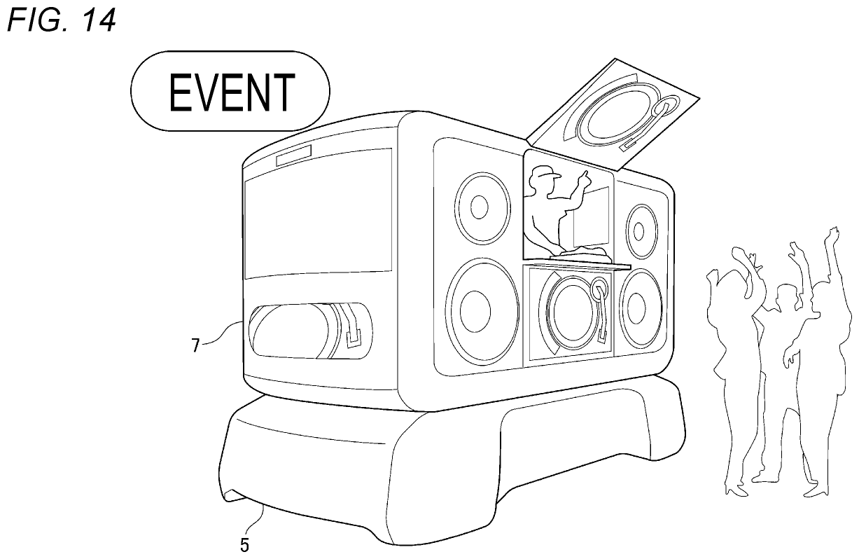

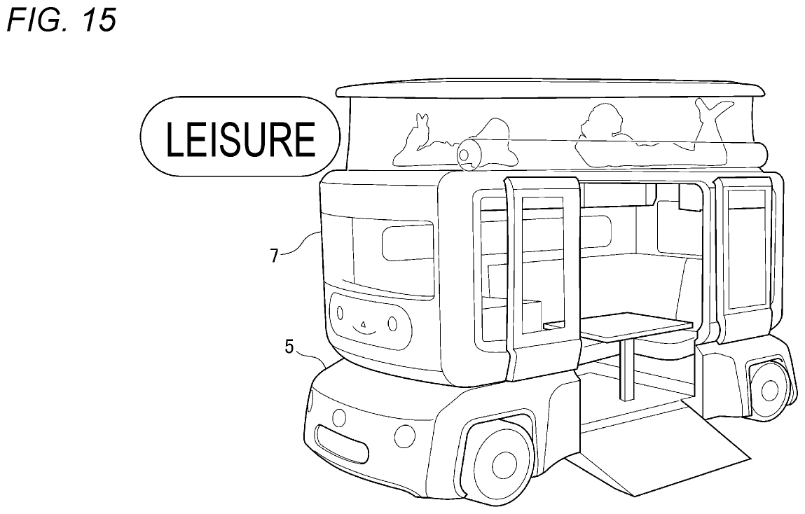

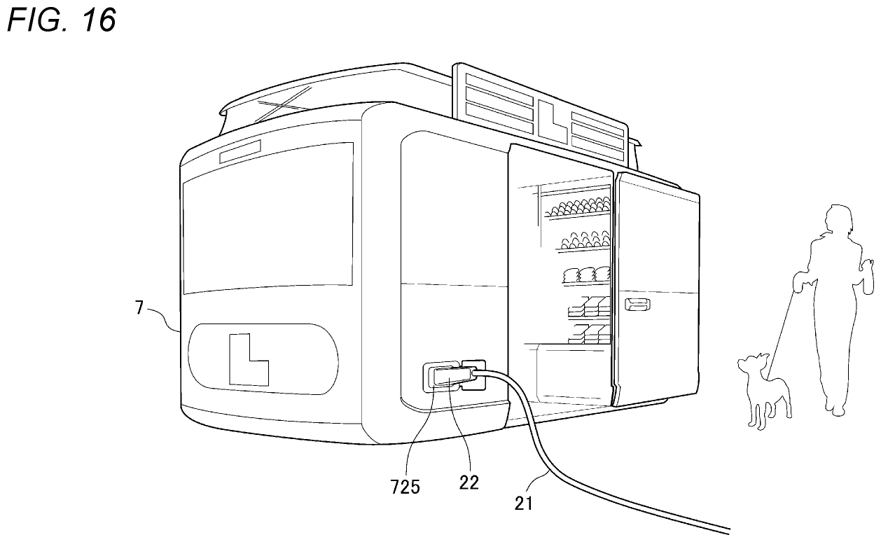

The BMS 721 has the same function as that of the BMS 518 of the self-propelled carriage unit 5, detects a total voltage, a remaining capacity, and the like of the battery 720 in real time, warns an input and output current and an overcurrent, and controls a dedicated charger. The charger 722 charges the battery 720 with electric power supplied from an external power supply (not shown) through the charging connector 725. When the battery 720 is charged with the electric power from the external power supply, a cable (not shown) of the external power supply is connected to the charging connector 725. FIG. 16 is a perspective view showing a state where the battery 720 of the cabin unit 7 is charged by the external power supply. As shown in FIG. 16, a connector 22 of a cable 21 from the external power supply is connected to the charging connector 725.

In this way, when the cabin unit 7 is mounted on the self-propelled carriage unit 5, the battery 720 of the cabin unit 7 can be charged by the electric power of the battery 517 of the self-propelled carriage unit 5, but when the cabin unit 7 is not mounted on the self-propelled carriage unit 5, the battery 720 of the cabin unit 7 can be charged by the electric power from the external power supply. The charging control unit 723 is controlled by the BMS 721 and controls charging of the battery 720 such that the battery 720 is not overcharged.

Here, details of battery control of the vehicle control ECU 516 of the self-propelled carriage unit 5 will be described.

When the cabin unit 7 is mounted on the self-propelled carriage unit 5, when a voltage of the battery (first secondary battery) 517 of the self-propelled carriage unit 5 is smaller than a first value, and when a voltage of the battery (second secondary battery) 720 of the cabin unit 7 is larger than a second value, the vehicle control ECU 516 of the self-propelled carriage unit 5 charges the battery 517 based on the fourth electric power output from the battery 720. That is, the electric power is charged from the battery 720 having a high voltage to the battery 517 having a low voltage.

When the cabin unit 7 is mounted on the self-propelled carriage unit 5, when the voltage of the battery (second secondary battery) 720 is smaller than a third value, and when the voltage of the battery (first secondary battery) 517 is larger than a fourth value, the vehicle control ECU 516 of the self-propelled carriage unit 5 charges the battery 720 based on the third electric power output from the battery 517. That is, the electric power is charged from the battery 517 having a high voltage to the battery 720 having a low voltage.

When the cabin unit 7 is mounted on the self-propelled carriage unit 5, the vehicle control ECU 516 of the self-propelled carriage unit 5 charges the battery 517 based on the fourth value output from the battery (second secondary battery) 720 based on a use schedule of the cabin unit 7. Here, the use schedule is, for example, “business plan of one day”. For example, in a case of a moving convenience store (convenience store), the cabin unit 7 is moved to a business place based on the business plan of one day, and is returned to a garage or a warehouse after business. Based on the business plan, when the cabin unit 7 is mounted on the self-propelled carriage unit 5 to move, in a case where a schedule thereafter is a schedule for returning to the garage and being charged, the battery 720 of the cabin unit 7 is not used for business. In such a scenario, a using method of the cabin unit 7 is to play a role of charging a battery side with power is formed. The use schedule may be given from the management server 3 or may be directly written in a memory of the vehicle control ECU 516.

When the cabin unit 7 is mounted on the self-propelled carriage unit 5, the vehicle control ECU 516 of the self-propelled carriage unit 5 charges the battery 720 based on the third electric power output from the battery (first secondary battery) 517 based on a movement schedule of the self-propelled carriage unit 5. Here, the movement schedule is, for example, a “traveling plan of one day”. For example, the self-propelled carriage unit 5 also has the traveling plan of one day in advance, and when the cabin unit 7 is mounted to move, and in a case where a remaining amount of the battery 517 is large for a traveling plan until the self-propelled carriage unit 5 is charged thereafter, although similar to the using method in the above-described scenario in a case of the use schedule, a using method of the self-propelled carriage 5 is to play a role of charging the battery 720 of the cabin unit 7. The movement schedule may be given from the management server 3 or may be directly written in the memory of the vehicle control ECU 516.

In addition to the configuration in which the wireless communication circuit 511 of the self-propelled carriage unit 5 receives the instruction from the management server 3 and the vehicle control ECU 516 charges the battery 720 of the cabin unit 7 based on the third electric power output from the battery 517 of the self-propelled carriage unit 5 in response to the instruction, the wireless communication circuit 511 and the vehicle control ECU 516 may be provided in the cabin unit 7 such that the vehicle control ECU 516 charges the battery 517 of the self-propelled carriage unit 5 based on the fourth electric power output from the battery 720 of the cabin unit 7 in response to the external instruction received by the wireless communication circuit 511. In this case, in addition to enabling both the case where the battery 720 of the cabin unit 7 is charged using the third electric power output from the battery 517 of the self-propelled carriage unit 5 and the case where the battery 517 of the self-propelled carriage unit 5 is charged using the fourth electric power output from the battery 720 of the cabin unit 7, only one of the cases may be enabled.

The battery may be provided only on a self-propelled carriage unit 5 side, or the battery may be provided only on a cabin unit 7 side.

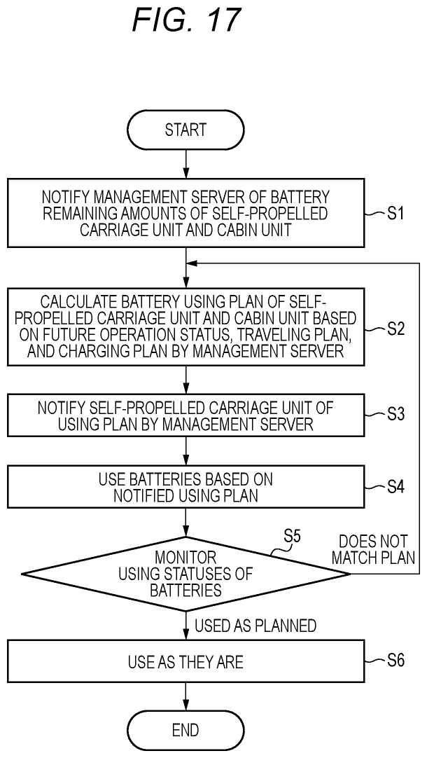

FIG. 17 is a flowchart for illustrating an operation of the vehicle 2 of the moving body management system 1 of the first embodiment. The flowchart shown in FIG. 17 shows operations of the vehicle 2 and the management server 3. In FIG. 17, first, in the vehicle 2, the management server 3 is notified of battery remaining amounts of the battery 517 of the self-propelled carriage unit 5 and the battery 720 of the cabin unit 7 (step S1). That is, the vehicle control ECU 516 of the self-propelled carriage unit 5 of the vehicle 2 acquires the battery remaining amount of the battery 517 from the BMS 518 of the self-propelled carriage unit 5, and acquires the battery remaining amount of the battery 720 from the BMS 721 of the cabin unit 7. Then, the management server 3 is notified of the acquired battery remaining amounts of the batteries 517 and 720.

When receiving the notification of the battery remaining amounts of the batteries 517 and 720 from the vehicle 2, the management server 3 calculates a battery using plan of the self-propelled carriage unit 5 and the cabin unit 7 based on a future operation status, the traveling plan, and a charging plan (step S2). Next, the management server 3 notifies the self-propelled carriage unit 5 of the calculated battery using plan (step S3).

When the self-propelled carriage unit 5 is notified of the battery using plan, the vehicle control ECU 516 of the self-propelled carriage unit 5 uses the batteries 517 and 720 based on the using plan notified from the management server 3 (step S4). When starting using the batteries 517 and 720, the vehicle control ECU 516 monitors using statuses of the batteries 517 and 720 (step S5). When the using of the batteries 517 and 720 does not match the plan, the vehicle control ECU 516 returns to the processing of step S2. On the contrary, when the batteries 517 and 720 are used as planned, the batteries 517 and 720 are used as they are (step S6), and the present processing ends.

As described above, according to the vehicle 2 that constitutes the moving body management system 1 of the first embodiment, various control methods are possible by mounting the batteries on both the self-propelled carriage unit 5 and the cabin unit 7, and this is effective in the following cases.

(1) The battery 517 of the self-propelled carriage unit 5 can be charged while using the battery 720 of the cabin unit 7 during traveling, and a traveling distance of the self-propelled carriage unit 5 can be extended.

(2) When returning to a warehouse at a moving store or the like, in a case where there is a remaining battery remaining amount, the remaining battery remaining amount can be used for electric power for traveling and charging of the self-propelled carriage unit 5.

(3) It is possible to calculate a charging time after traveling and a charging timing for extending lives of the batteries 517 and 720 based on the traveling plan and the battery remaining amounts on the self-propelled carriage unit 5 side and the cabin unit 7 side, to control which battery is to be used, and to implement efficient reusing of the batteries by performing control on a management server 3 side.

Since when the battery is provided only on the self-propelled carriage unit 5 side, the electric power is not used on the cabin unit 7 side, or when an external power supply is available at a movement destination, it is not necessary to mount the battery 720 on the cabin unit 7 side, a degree of freedom in designing of the cabin unit 7 is increased, a weight is also reduced, and electric power consumption is improved. Further, since the battery itself is not mounted, a cost is also reduced. In contrast, when the battery 720 is mounted only on the cabin unit 7 side, the self-propelled carriage unit 5 side needs to be always mounted with a cabin unit including a battery to travel, but when the battery is consumed, the cabin unit is replaced with a cabin unit that has been charged, so that the self-propelled carriage unit 5 is continuously operated without having a charging time. Accordingly, an asset of the vehicle 2 itself can be reduced.

A moving body of the first embodiment includes: a first body that includes at least one wheel and that is configured to travel by the wheel; and a second body attachable to and detachable from the first body, in which the first body includes an electric motor configured to drive the at least one wheel, and a first secondary battery configured to supply first electric power to the electric motor, in which the second body includes a predetermined electric power load and a second secondary battery configured to supply second electric power to the predetermined electric power load, and in which when the second body is mounted on the first body, the second secondary battery is charged using third electric power output from the first secondary battery, and/or the first secondary battery is charged using fourth electric power output from the second secondary battery.

With this configuration, since the secondary batteries are mounted on both the first body and the second body, it is possible to control whether the secondary battery on a first body side is used or the secondary battery on a second body side is used depending on a situation, and it is possible to maximize a traveling distance of the first body and to control an optimal charging timing. Further, it is possible to efficiently use both the secondary batteries, for example, to lengthen lives of both the secondary batteries. For example, in a case where a capacity of the secondary battery for going to the destination is insufficient in the first body, when the capacity can be compensated by performing charging with the secondary battery of the second body, it is possible to go to the destination without replacing the self-propelled carriage unit with another self-propelled carriage unit on the way. Further, since there is no need to go to the replacement point, there is no need to go to a detour route.

In the moving body of the first embodiment, in the above-described configuration, the predetermined electric power load of the second body includes at least one of a first light disposed on an outer side of the second body, a second light disposed on an inner side of the second body, an electric compressor disposed in the second body, an electric fan disposed in the second body, a first display disposed inside the second body, and a second display disposed on a side surface outside the second body.

With this configuration, the predetermined electric power load disposed in the second body can be operated by the second secondary battery, and when the capacity of the second secondary battery is reduced, the second secondary battery can be charged by the first secondary battery of the first body, so that it is possible to operate the predetermined electric power load over a long period of time.

In the moving body of the first embodiment, in the above-described configuration, when the second body is not mounted on the first body, the second body is installed on ground.

With this configuration, when the second body is not mounted on the first body, the second body can be installed on the ground.

In the moving body of the first embodiment, in the above-described configuration, when the second body is not mounted on the first body, the second secondary battery of the second body is charged by electric power from an external power supply.

With this configuration, when the second body is not mounted on the first body, the second secondary battery of the second body can be charged with electric power from the external power supply.

In the moving body of the first embodiment, in the above-described configuration, the electric motor is configured to drive the at least one wheel based on the first electric power output from the first secondary battery and the fourth electric power output from the second secondary battery.

With this configuration, the wheel can be driven by both the first electric power output from the first secondary battery of the first body and the fourth electric power output from the second secondary battery of the second body.

In the moving body of the embodiment, in the above-described configuration, when the second body is mounted on the first body, when a voltage of the first secondary battery is smaller than a first value, and when a voltage of the second secondary battery is larger than a second value, the first secondary battery is charged using the fourth electric power output from the second secondary battery.

With this configuration, when the second body is mounted on the first body, the voltage of the first secondary battery of the first body is smaller than the first value, and the voltage of the second secondary battery of the second body is larger than the second value, the first secondary battery can be charged with the fourth electric power output from the second secondary battery.

In the moving body of the first embodiment, in the above-described configuration, when the second body is mounted on the first body, when a voltage of the second secondary battery is smaller than a third value, and when a voltage of the first secondary battery is larger than a fourth value, the second secondary battery is charged using the third electric power output from the first secondary battery.

With this configuration, when the second body is mounted on the first body, the voltage of the second secondary battery of the second body is smaller than the third value, and the voltage of the first secondary battery of the first body is larger than the fourth value, the second secondary battery can be charged with the third electric power output from the first secondary battery.

In the moving body of the first embodiment, in the above-described configuration, when the second body is mounted on the first body, the first secondary battery is charged using the fourth electric power output from the second secondary battery based on a use schedule of the second body.

With this configuration, when the second body is mounted on the first body, the first secondary battery can be charged with the fourth electric power output from the second secondary battery based on the use schedule of the second body.

In the moving body of the first embodiment, in the above-described configuration, when the second body is mounted on the first body, the second secondary battery is charged using the third electric power output from the first secondary battery based on a movement schedule of the first body.

With this configuration, when the second body is mounted on the first body, the second secondary battery can be charged with the third electric power output from the first secondary battery based on the movement schedule of the first body.

In the moving body of the first embodiment, in the above-described configuration, the first body and/or the second body include(s) a wireless communication circuit, and in response to an external instruction received by the wireless communication circuit, the second secondary battery is charged using the third electric power output from the first secondary battery and/or the first secondary battery is charged using the fourth electric power output from the second secondary battery.

With this configuration, the second secondary battery of the second body can be charged with the third electric power output from the first secondary battery of the first body, and the first secondary battery of the first body can be charged with the fourth electric power output from the second secondary battery of the second body, by a wireless operation.

According to the first embodiment, it is possible to provide a moving body that can maximize a traveling distance of a first body and control an optimal charging timing.

### Second Embodiment

Next, a moving body management system of a second embodiment will be described.

The moving body management system 15 of the second embodiment is a vehicle having a separation structure including a self-propelled carriage unit and a cabin unit attachable to and detachable from the self-propelled carriage unit, and has a function of, when the cabin unit is mounted on the self-propelled carriage unit, acquiring attribute information of the cabin unit and switching traveling control of autonomous traveling based on the acquired attribute information by the self-propelled carriage unit.

Since the function of switching the traveling control is provided, particularly, when an infant, a toddler, or an elderly person is placed in the cabin unit, it is possible to change traveling conditions such as acceleration during acceleration and deceleration and acceleration during turning in which riding comfort is emphasized, and to perform safe traveling without causing motion sickness, and when the cabin unit carries a fragile object or an object weak to vibration as a cargo, not only acceleration is changed to acceleration for carrying safely, but also the cargo can be carried safely while avoiding a rough road with large vibration, a steep slope, or a traffic jam.

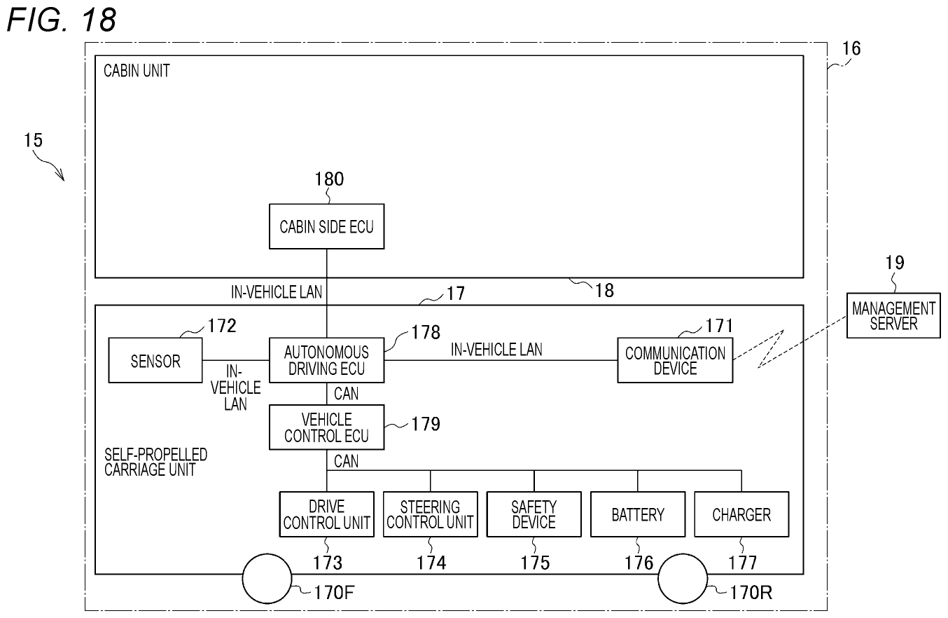

FIG. 18 is a block diagram showing a schematic configuration of the moving body management system 15 of the second embodiment. In FIG. 18, the moving body management system 15 of the present embodiment includes a vehicle 16 and a management server 19. The vehicle 16 is a moving body that operates autonomously. The management server 19 provides the vehicle 16 with external information such as weather information and traffic information (traffic jam, accident regulation, and the like).

The vehicle 16 includes a self-propelled carriage unit (corresponding to “first body”) 17, and a cabin unit mounted on the self-propelled carriage unit 17 (corresponding to “second body”) 18. The self-propelled carriage unit 17 includes two front wheels 170F (only one of the two front wheels 170F is shown in FIG. 18) and two rear wheels 170R (only one of the two rear wheels 170R is shown in FIG. 18), and travels by the two front wheels 170F and the two rear wheels 170R. The two front wheels 170F are steered wheels, and the rear wheels 170R are driven wheels. Incidentally, the front wheel is a wheel on a front side when a vehicle travels forward, and the rear wheel is a wheel on a side opposite to the front wheel. Instead of using the front wheels 170F as the steered wheels and the rear wheels 170R as the driven wheels, the steered wheels may also serve as the driven wheels (a drive system referred to as so-called FF). Further, the self-propelled carriage unit 17 is a four-wheeled vehicle including the four wheels 170F and 170R, but may be a single-wheeled vehicle including one wheel. That is, at least one wheel may be provided.

The self-propelled carriage unit 17 includes, in addition to the wheels 170F and 170R described above, a communication device 171, a sensor 172, a drive control unit 173, a steering control unit 174, a safety device 175, a battery 176, a charger 177, an autonomous driving ECU (attribute information acquisition circuit) 178, and a vehicle control ECU 179. The communication device 171 performs wireless communication with the management server 19, and acquires the external information such as the weather information and the traffic information (traffic jam, accident regulation, and the like). A dedicated frequency band, a frequency band of moving body communication, or the like is used for the wireless communication by the communication device 171. The sensor 172 is directed to an outside of the self-propelled carriage unit 17 of the vehicle 16, is disposed on an end portion in a predetermined traveling direction, and is used to monitor a front side in the predetermined traveling direction. For example, a camera or a Lidar is used as the sensor 172. Information of the sensor 172 is taken into the autonomous driving ECU 178.

The drive control unit 173 controls an electric motor (not shown) that provides a drive force to the two driven wheels 170R that are driven wheels of the self-propelled carriage unit 17. The steering control unit 174 performs control to change a wheel angle of the two wheels 170F that are steered wheels of the self-propelled carriage unit 17. The wheel angle refers to an angle of a wheel with respect to a direction of the wheel when the self-propelled carriage unit 17 travels straight, and may be generally referred to as a tire angle. The safety device 175 is a component for ensuring safety, such as a light and a direction indicator. The battery 176 supplies electric power to the above-described electric motor (not shown). The charger 177 charges the battery 176 with electric power supplied from an external power supply (not shown).

The autonomous driving ECU 178 generates information for the self-propelled carriage unit 17 to autonomously travel by using the information from the sensor 172, and outputs the generated information to the vehicle control ECU 179. The autonomous driving ECU 178 includes a CPU, a ROM that stores a program for controlling the CPU, and a RAM used for an operation of the CPU (not shown). Details of control of the autonomous driving ECU 178 will be described later. The vehicle control ECU 179 controls the drive control unit 173, the steering control unit 174, and the safety device 175 in accordance with the information for the autonomous traveling from the autonomous driving ECU 178.

The communication device 171 and the sensor 172 are connected to the autonomous driving ECU 178 by an in-vehicle LAN. Further, the autonomous driving ECU 178 and the vehicle control ECU 179 are connected to each other by a controller area network (CAN). Further, the drive control unit 173, the steering control unit 174, the safety device 175, the battery 176, and the charger 177 are also connected to the vehicle control ECU 179 by the CAN. The communication device 171 and the sensor 172 may be wirelessly connected to the autonomous driving ECU 178. The vehicle control ECU 179 includes a CPU, a ROM that stores a program for controlling the CPU, and a RAM used for an operation of the CPU (not shown).

In contrast, the cabin unit 18 is provided with a cabin side ECU (attribute information holding unit) 180. The cabin side ECU 180 holds the attribute information, but holding of the attribute information may be implemented by an electric circuit such as a memory circuit, or may be implemented by an object other than the electric circuit such as a barcode. The cabin side ECU 180 is connected to the autonomous driving ECU 178 of the self-propelled carriage unit 17 by the in-vehicle LAN. The cabin side ECU 180 manages a mounted object of the cabin unit 18, and when there is a notification to request the mounted object of the cabin unit 18 from the autonomous driving ECU 178 of the self-propelled carriage unit 17, the cabin side ECU 180 notifies the autonomous driving ECU 178 of the self-propelled carriage unit 17 of cabin unit mounting information (attribute information) indicating the mounted object of the cabin unit 18.

In the present embodiment, the autonomous driving ECU 178 of the self-propelled carriage unit 17 directly acquires the attribute information held by the cabin side ECU 180 of the cabin unit 18, but the management server 19 may hold the attribute information, and the autonomous driving ECU 178 of the self-propelled carriage unit 17 may acquire the attribute information from the management server 19. That is, the cabin side ECU 180 of the cabin unit 18 may hold identification information of the cabin unit 18, the management server 19 may hold the attribute information, and the autonomous driving ECU 178 may acquire the identification information held by the cabin side ECU 180, and may acquire the attribute information corresponding to the identification information via the communication device (wireless communication circuit) 171. In this case, holding of the identification information of the cabin side ECU 180 may be implemented by an electric circuit such as a memory circuit, or may be implemented by an object other than the electric circuit such as a barcode. Instead of acquiring the attribute information from the management server 19, the autonomous driving ECU 178 may acquire information itself of traveling control of autonomous traveling to switch traveling control.

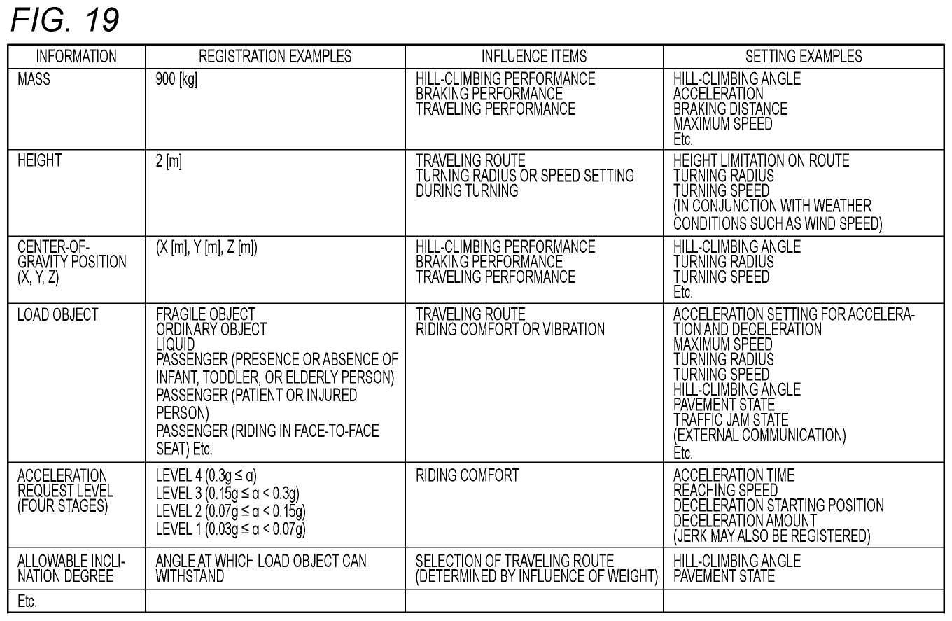

Here, FIG. 19 is a table showing an example of the cabin unit mounting information held by the cabin side ECU 180. As shown in FIG. 19, cabin unit registration information includes, in addition to a mass of the cabin unit 18, a height in a vertical direction of an outline of the cabin unit 18 (cabin unit outline), and a center-of-gravity position, an attribute of a load object, an acceleration request level, an allowable inclination degree, and the like. As a registration example, the mass of the cabin unit 18 is 900 [kg], the height is 2 [m], and the center-of-gravity position (X, Y, Z) is X [m], Y [m], and Z [m]. An influence item shown in the drawing is an influence on the vehicle (vehicle 16), and in a case of the vehicle, includes a weight, a type and a limitation of the load object, a center of gravity, a mounting or seated direction, and the like. Further, in a case of a road surface, the influence item includes a pavement state, an inclination degree, and the like. Further, in a case of an outside, the influence item includes weather, a traffic jam, accident construction, and the like. In contrast, conditions under which the vehicle is influenced include a torque, acceleration, decelerating acceleration, lateral acceleration, a turning radius, hill-climbing performance, a cruising distance, and the like at the start of movement.

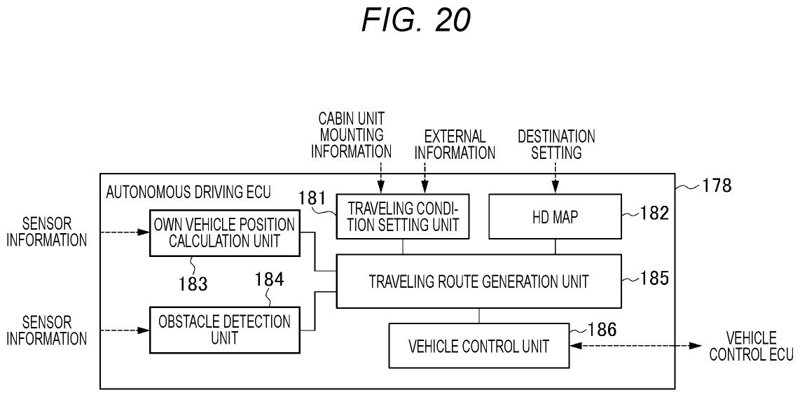

FIG. 20 is a block diagram showing a schematic configuration of the autonomous driving ECU 178. In FIG. 20, the autonomous driving ECU 178 includes a traveling condition setting unit 181, an HD map 182, an own vehicle position calculation unit 183, an obstacle detection unit 184, a traveling route generation unit 185, and a vehicle control unit 186. The traveling condition setting unit 181 sets traveling conditions of the vehicle 16 based on the cabin unit mounting information provided from the cabin unit 18 and external information such as the weather information and the traffic information (traffic jam, accident regulation, and the like) provided from the management server 19. The HD map 182 includes a high-precision 3D (dimensional) map, and outputs map information of a destination set as a destination. The own vehicle position calculation unit 183 detects an own vehicle position, that is, a position of the vehicle 16, based on sensor information from the sensor 172. The sensor information for position detection is, for example, information from the above-described Lidar. The obstacle detection unit 184 mainly detects an obstacle ahead in a traveling direction of the vehicle 16. The sensor information for obstacle detection is, for example, information (video information) from a camera.

The traveling route generation unit 185 generates a traveling route based on the traveling conditions set by the traveling condition setting unit 181, the map information output from the HD map 182, the own vehicle position calculated by the own vehicle position calculation unit 183, and the obstacle detected by the obstacle detection unit 184. The vehicle control unit 186 performs vehicle control for causing the vehicle to travel along the traveling route generated by the traveling route generation unit 185. The vehicle control unit 186 performs vehicle control on the vehicle control ECU 179.

Next, an operation of the moving body management system 15 of the second embodiment will be described.

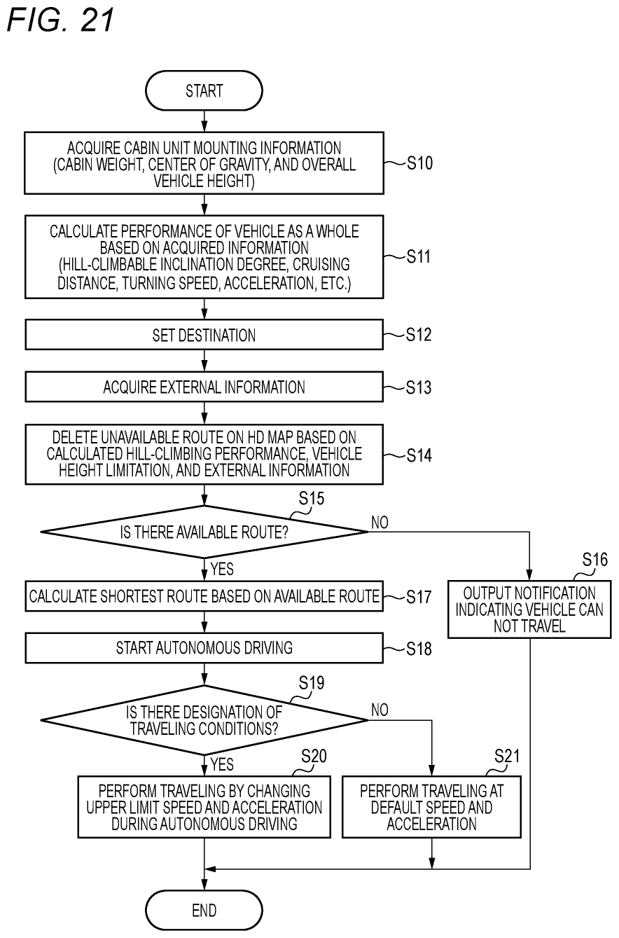

FIG. 21 is a flowchart for illustrating an operation of the autonomous driving ECU 178 of the self-propelled carriage unit 17. In FIG. 21, the autonomous driving ECU 178 first acquires the cabin unit mounting information from the cabin side ECU 180 (step S10). The acquired cabin unit mounting information includes a cabin weight, a center of gravity, and an overall height. The autonomous driving ECU 178 calculates performance of the vehicle 16 as a whole based on the acquired cabin unit mounting information (step S11). The performance calculated by the autonomous driving ECU 178 includes a hill-climbable inclination degree, a cruising distance, a turning speed, acceleration, and the like. After calculating the performance of the vehicle 16 as a whole, the autonomous driving ECU 178 sets a destination (step S12). Input of the destination is performed by a person. The autonomous driving ECU 178 sets the destination input by the person.

After setting the destination, the autonomous driving ECU 178 acquires external information from the management server 19 (step S13). The external information includes the weather information, the traffic information (the traffic jam, the accident regulation, and the like), and the like. After acquiring the external information from the management server 19, the autonomous driving ECU 178 deletes an unavailable route on the HD map 182 based on the calculated hill-climbing performance, a vehicle height limitation, and the external information (step S14). Next, the autonomous driving ECU 178 determines whether there is an available route among remaining routes obtained by deleting the unavailable route (step S15). When determining that there is no available route (when determining as “No” in step S15), the autonomous driving ECU 178 notifies the management server 19 that the vehicle can not travel (step S16). After notifying the management server 19 that the vehicle can not travel, the autonomous driving ECU 178 ends the present processing. When determining in the determination of step S15 that there is the available route (when determining as “Yes”), the autonomous driving ECU 178 calculates a shortest route based on the available route (step S17). As the shortest route, it is also possible to select a riding comfort priority route. The riding comfort priority route is a route that satisfies, for example, a good paved state of a roadway, a small number of ups and downs, a small number of signals, and a small number of traffic jams.

After calculating the shortest route based on the available route, the autonomous driving ECU 178 starts autonomous driving (step S18). That is, the self-propelled carriage unit 17 is caused to travel along the calculated shortest route. After the autonomous driving is started, the autonomous driving ECU 178 determines whether there is designation of traveling conditions (step S19). When determining that there is no designation of the traveling conditions (when determining as “No” in step S19), the autonomous driving ECU 178 causes the self-propelled carriage unit 17 to travel at a default speed and acceleration. The autonomous driving ECU 178 causes the self-propelled carriage unit 17 to travel to the destination at the default speed and acceleration, and then ends the present processing. When determining in step S19 that there is the designation of the traveling conditions (when determining as “Yes”), the autonomous driving ECU 178 causes the self-propelled carriage unit 17 to travel by changing an upper limit speed and acceleration during the autonomous driving. Then, when the self-propelled carriage unit 17 reaches the destination, the present processing is ended. It is possible to perform driving with priority on riding comfort, and the driving with the priority on the riding comfort is driving with reduced number of acceleration and deceleration, driving with reduced acceleration, or the like.

Next, an overview of control when there is a limitation to a vehicle height of the vehicle 16 will be described.

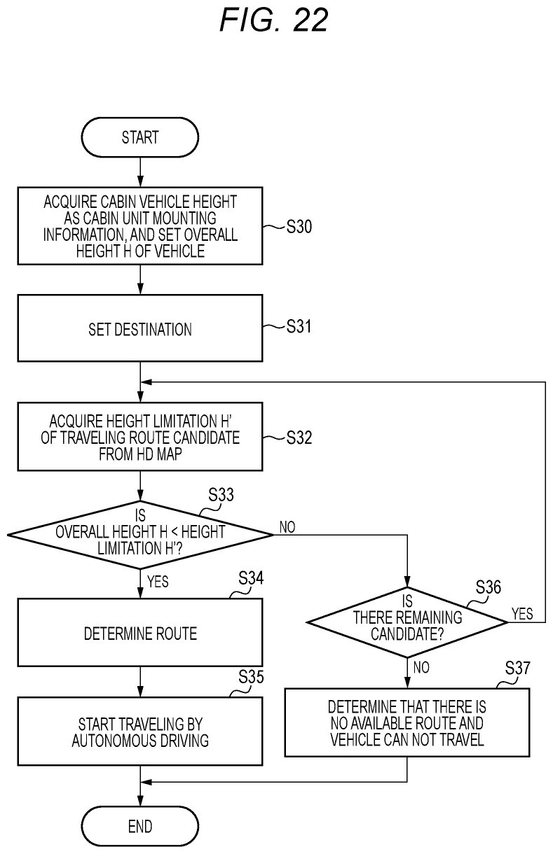

FIG. 22 is a flowchart for illustrating an operation of the autonomous driving ECU 178 when there is the limitation to the vehicle height of the vehicle 16. In FIG. 22, the autonomous driving ECU 178 first acquires a cabin vehicle height as the cabin unit mounting information from the cabin side ECU 180, and sets an overall height H of the vehicle (step S30).

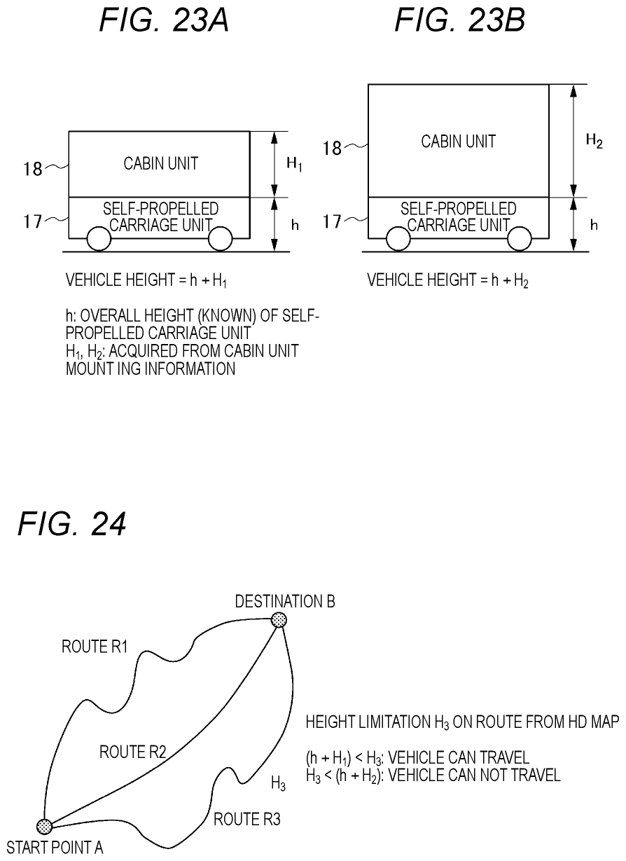

Here, FIGS. 23A and 23B are diagrams showing vehicle heights of the vehicle 16. In a case of FIG. 23A, a vehicle height of the self-propelled carriage unit 17 is h, a vehicle height of the cabin unit 18 is H₁, and the vehicle height of the vehicle 16 is h+H₁. In contrast, in a case of FIG. 23B, the vehicle height of the self-propelled carriage unit 17 is h, the vehicle height of the cabin unit 18 is H₂, and the vehicle height of the vehicle 16 is h+H₂. In this case, the vehicle height h of the self-propelled carriage unit 17 is known, and the vehicle heights H₁ and H₂ of the cabin unit 18 can be acquired from the cabin unit mounting information.

Returning to FIG. 22, after setting the overall height H of the vehicle, the autonomous driving ECU 178 sets a destination (step S31). Next, the autonomous driving ECU 178 acquires a height limitation H′ of a traveling route candidate from the HD map 182 (step S32). Next, the autonomous driving ECU 178 determines whether the overall height H of the vehicle is less than the height limitation H′ (H<H′) (step S33). When determining that the traveling route candidate is equal to or larger than the height limitation H′ (when determining as “No” in step S33), the autonomous driving ECU 178 determines whether there is a remaining candidate (traveling route candidate) (step S36). When determining that there is the remaining candidate (when determining as “Yes” in step S36), the autonomous driving ECU 178 returns to step S32. When determining that there is no remaining candidate (when determining as “No” in step S36), the autonomous driving ECU 178 determines that there is no available route and the vehicle can not travel (step S37), and ends the present processing.

When determining in the determination of step S33 that the traveling route candidate is less than the height limitation H′ (when determining as “Yes” in step S33), the autonomous driving ECU 178 determines the traveling route candidate (step S34) and starts traveling by autonomous driving (step S35). After causing the self-propelled carriage unit 17 on which the cabin unit 18 is mounted to travel to the destination, the autonomous driving ECU 178 ends the present processing.

FIG. 24 is a diagram showing a case where there are three traveling route candidates. For example, in a case where a height limitation H₃ is acquired in a route R3 shown in FIG. 24, when the height of the vehicle including the self-propelled carriage unit 17 of the height h and the cabin unit 18 of the height H₁ is less than the height limitation H₃, traveling in the route R3 is possible, but when the height of the vehicle including the self-propelled carriage unit 17 of the height h and the cabin unit 18 of the height H₂ exceeds the height limitation H₃, the traveling in the route R3 is not possible.

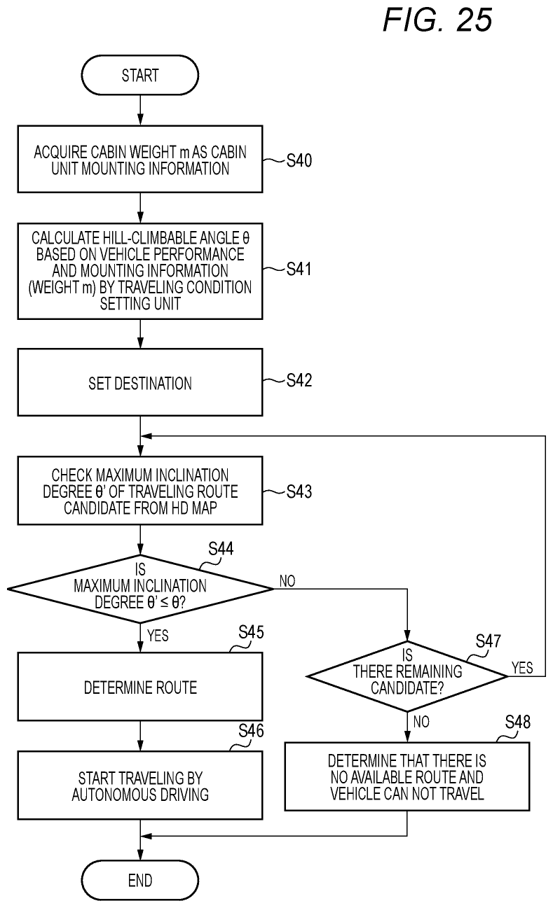

FIG. 25 is a flowchart for illustrating an operation of the autonomous driving ECU 187 when there is a braking limit on a downhill. In FIG. 25, the autonomous driving ECU 178 first acquires a cabin weight m as the cabin unit mounting information from the cabin side ECU 180 (step S40). After acquiring the cabin weight m, the autonomous driving ECU 178 calculates a hill-climbable angle θ based on vehicle performance and mounting information (weight m) by the traveling condition setting unit 181 (step S41).

After calculating the hill-climbable angle θ, the autonomous driving ECU 178 sets a destination (step S42). An HMI (not shown), the management server 19, or the like is used for setting the destination. Next, the autonomous driving ECU 178 checks a maximum inclination degree θ′ of a traveling route candidate from the HD map 182 (step S43), and determines whether the maximum inclination degree θ′ of the candidate route is equal to or smaller than the hill-climbable angle θ (step S44). When determining that the maximum inclination degree θ′ of the candidate route is not equal to or smaller than the hill-climbable angle θ (when determining as “No” in step S44, that is, when determining that the maximum inclination degree θ′ of the candidate route exceeds the hill-climbable angle θ), the autonomous driving ECU 178 determines whether there is a remaining candidate (step S47). When determining that there is the remaining candidate (when determining as “Yes” in step S47), the autonomous driving ECU 178 returns to step S43. When determining that there is no remaining candidate (when determining as “No” in step S47), the autonomous driving ECU 178 determines that there is no available route and it is not possible to travel (step S48), and ends the present processing.

When determining in the determination of step S44 that the maximum inclination degree θ′ of the candidate route is equal to or smaller than the hill-climbable angle θ (when determining as “Yes” in step S44), the autonomous driving ECU 178 determines the traveling route candidate (step S45), and starts traveling by autonomous driving (step S46). After causing the self-propelled carriage unit 17 on which the cabin unit 18 is mounted to travel to the destination, the autonomous driving ECU 178 ends the present processing.

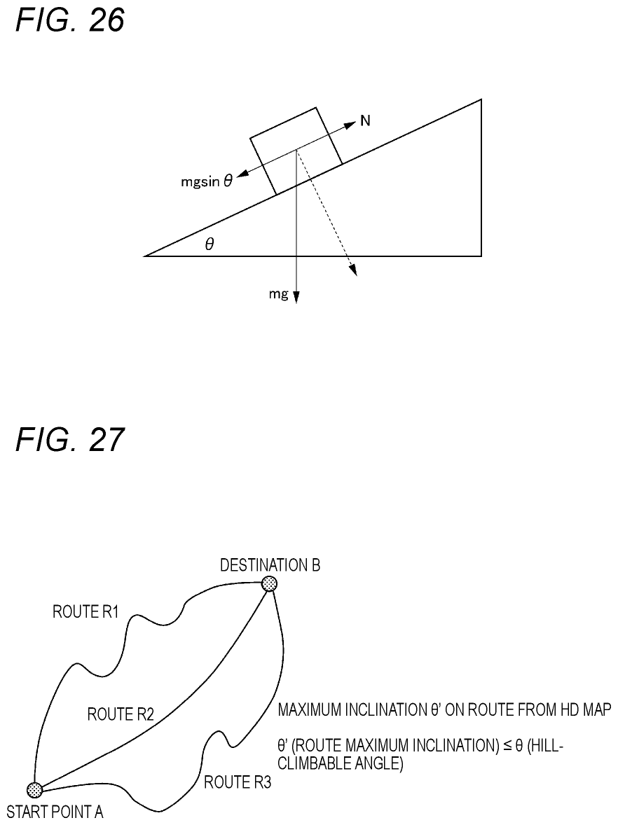

FIG. 26 is a diagram showing a relationship between the hill-climbable angle θ and a brake braking force of the vehicle 16. In FIG. 26, “N” indicates the brake braking force, “m” indicates the vehicle weight, and “g” indicates gravitational acceleration. Gravity mg acts vertically downward on the vehicle 16. Further, a downward force component is mg sin θ. When the brake braking force N is equal to or larger than mg sin θ, the brake braking force becomes effective. The angle θ is equal to or smaller than sin⁻¹(N/mg). The angle θ at which the brake braking force is effective on the downhill changes depending on the vehicle weight. Since the hill-climbing performance also changes depending on the same weight on an uphill, the inclination degree θ with which the vehicle can travel is determined depending on the weight m.

FIG. 27 is a diagram showing a case where there are three traveling route candidates. For example, when a maximum inclination degree of the route R3 shown in FIG. 27 is θ′, a condition under which the vehicle can travel on the route R3 is a case where the maximum inclination degree θ′ of the route R3 is equal to or smaller than the hill-climbable angle θ.

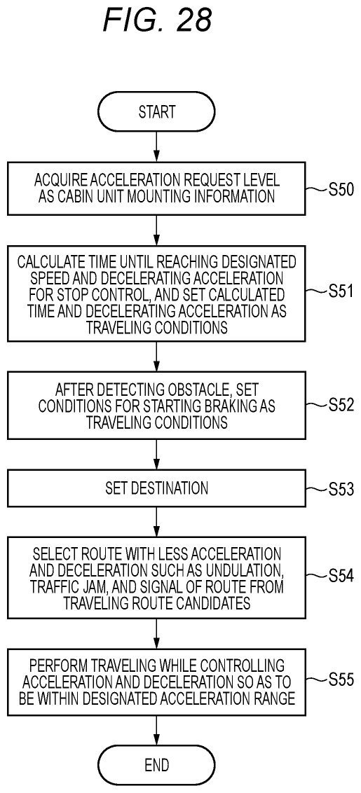

FIG. 28 is a flowchart for illustrating an operation of the autonomous driving ECU 178 when a distance and a timing at which a braking force is applied to stop braking in the vehicle 16 are controlled with the cabin unit mounting information. In FIG. 28, the autonomous driving ECU 178 first acquires an acceleration request level as the cabin unit mounting information from the cabin side ECU 180 (step S50). After acquiring the acceleration request level, the autonomous driving ECU 178 calculates a time until reaching a designated speed and decelerating acceleration for stop control, and sets the calculated time and decelerating acceleration as traveling conditions (step S51).

Next, after detecting an obstacle, the autonomous driving ECU 178 sets conditions for starting braking as the traveling conditions (step S52). Next, the autonomous driving ECU 178 sets a destination (step S53). After setting the destination, the autonomous driving ECU 178 selects a route with less acceleration and deceleration such as undulation, a traffic jam, and a signal of the route from traveling route candidates (step S54). Next, the autonomous driving ECU 178 travels while controlling acceleration and deceleration so as to be within a designated acceleration range (step S55).

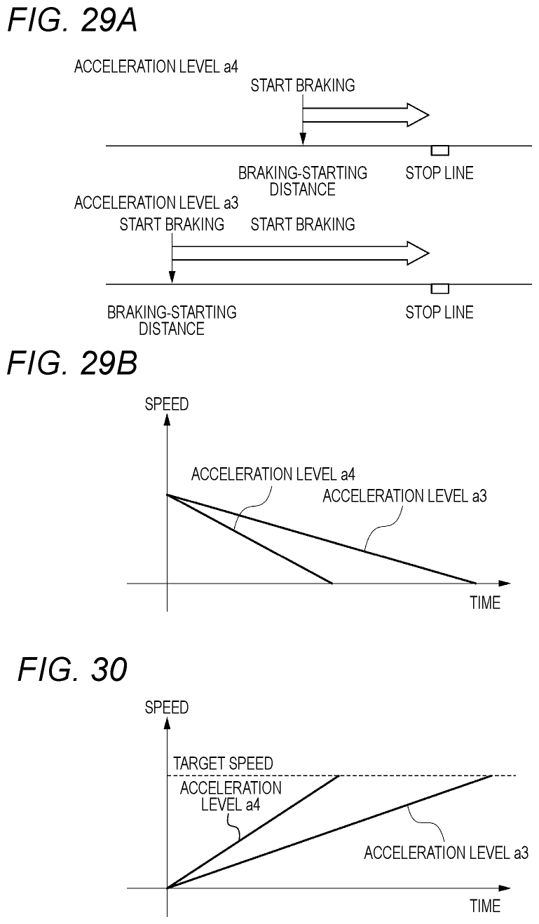

FIGS. 29A and 29B are diagrams showing an example of a braking distance change in accordance with an acceleration level. FIG. 29A shows a braking start timing and a braking start distance due to a difference in an acceleration level. As shown in FIG. 29A, an acceleration level a3 having a low acceleration level makes a distance from detection of an obstacle by the sensor 172 to application of braking longer than an acceleration level a4 having a high acceleration level. FIG. 29B shows a time until the vehicle stops due to a difference in the acceleration level. As shown in FIG. 29B, the acceleration level a3 having the low acceleration level makes a time from detection of the obstacle by the sensor 172 to stop of the vehicle longer than the acceleration level a4 having the high acceleration level. FIG. 30 is a diagram showing an example of a time until a target speed is reached due to a difference in the acceleration level. As shown in FIG. 30, the time until the target speed is reached is shorter at the acceleration level a4 having the high acceleration level than at the acceleration level a3 having the low acceleration level.

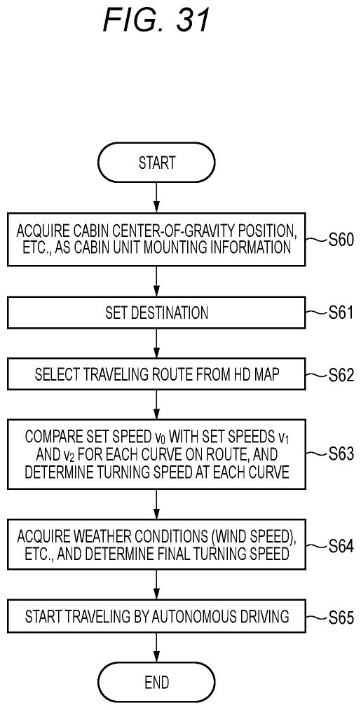

FIG. 31 is a flowchart for illustrating turning speed control of the autonomous driving ECU 178 of the self-propelled carriage unit 17. In FIG. 31, the autonomous driving ECU 178 first acquires a cabin center-of-gravity position, or the like as the cabin unit mounting information from the cabin side ECU 180 (step S60). Next, the autonomous driving ECU 178 sets a destination (step S61). In this case, the autonomous driving ECU 178 registers the destination by an HMI (not shown), the management server 19, or the like.

Next, the autonomous driving ECU 178 selects a traveling route from the HD map 182 (step S62). Then, a set speed v₀ is compared with set speeds v₁ and v₂ for each curve on the selected traveling route, and a turning speed at each curve is determined (step S63). After determining the turning speed at each curve on the selected traveling route, the autonomous driving ECU 178 acquires weather conditions (wind speed and the like) from the management server 19 and determines a final turning speed (step S64). Then, traveling by autonomous driving in consideration of the determined final turning speed is started (step S65). After causing the self-propelled carriage unit 17 on which the cabin unit 18 is mounted to travel to the destination, the autonomous driving ECU 178 ends the present processing.

The speeds v₁ and v₂ described above can be obtained as follows.

A center-of-gravity position is exemplified as a parameter that influences the turning speed.

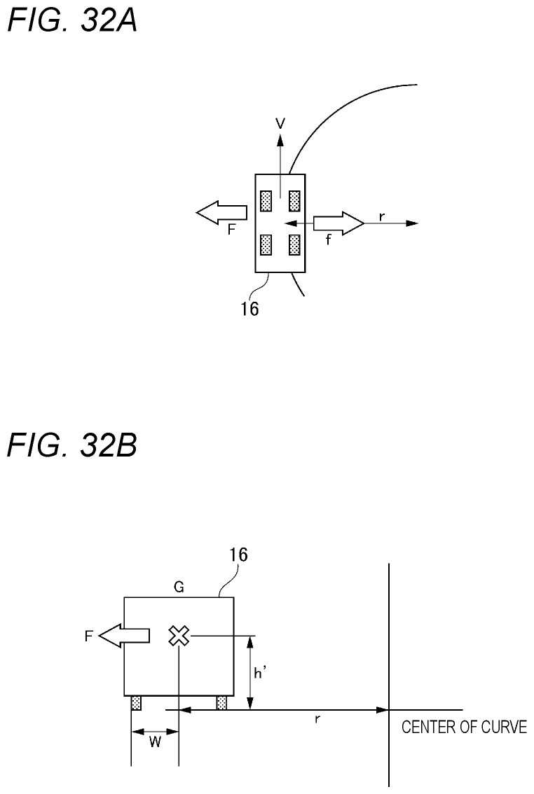

FIGS. 32A and 32B are explanatory diagrams for obtaining the turning speed of the vehicle 16.

rotation radius: r

total mass: m

turning speed: v

vehicle center of gravity: G

center of gravity height: h′

track width: 2w

gravitational acceleration: g

centrifugal force: F

friction coefficient: μ

frictional force toward rotation center: f

In a case of the above-described conditions, the centrifugal force F is expressed by F=mv²/r, and the frictional force toward rotation center f is expressed by f=μmg.

Since a limit speed v₁ with respect to sideslip is a speed satisfying F=f, the limit speed v₁ is expressed by the following equation.

$${v}_{1}^{2} = μ gr \\ {v}_{1} = {( μ gr )}^{1 / 2}$$

A moment M around a ground contact point of a left wheel with respect to floating of the left wheel is expressed by the following equation.

$$M = {Fh}^{′} - mg 2 w = {mv}^{2} {h}^{′} / r - mg 2 w$$

When M becomes equal to or larger than 0, the wheel tends to float.

Therefore, the limit speed v₂ with respect to the floating is expressed by the following equation.

$${mv}_{2}^{2} {h}^{′} / r = mg 2 w \\ {v}_{2}^{2} = g 2 wr / {h}^{′} \\ {v}_{2} = {( g 2 wr / {h}^{′} )}^{1 / 2}$$

A smaller one of v₁ and v₂ is set as the turning speed.

Since not only the center of gravity height but also the total mass and a height (vertical direction) are influenced by wind or the like, the turning speed can be changed in accordance with the weather conditions from the management server 19.

Here, the turning speed differs depending on a difference in a height of a center-of-gravity position of the cabin unit 18. For example, the cabin unit (second body) 18 includes at least a fifth type of second body and a sixth type of second body. A height of a center-of-gravity position of the fifth type of second body is a first height, and a height of a center-of-gravity position of the sixth type of second body is a second height higher than the first height. When the fifth type of second body is mounted on the cabin unit 18, a maximum speed for a predetermined turning radius in traveling control of autonomous traveling is a fifth speed. When the sixth type of second body is mounted on the cabin unit 18, the maximum speed for the predetermined turning radius in the traveling control of the autonomous traveling is a sixth speed lower than the fifth speed.

The turning speed also differs depending on a difference in a mass of the cabin unit 18. For example, the cabin unit (second body) 18 includes at least a first type of second body and a second type of second body. A mass of the first type of second body is a first weight, and a mass of the second type of second body is a second weight larger than the first weight. When the first type of second body is mounted on the cabin unit 18, the maximum speed for the predetermined turning radius in the traveling control of the autonomous traveling is a first speed. When the second type of second body is mounted on the cabin unit 18, the maximum speed for the predetermined turning radius in the traveling control of the autonomous traveling is a second speed lower than the first speed.

The turning speed also differs depending on a difference in a height in a vertical direction of the outline of the cabin unit 18. For example, the cabin unit (second body) 18 includes at least a third type of second body and a fourth type of second body. A height in a vertical direction of an outline of the third type of second body is a first length, and a height in a vertical direction of an outline of the fourth type of second body is a second length larger than the first length. When the third type of second body is mounted on the cabin unit 18, the maximum speed for the predetermined turning radius in the traveling control of the autonomous traveling is a third speed. When the fourth type of second body is mounted on the cabin unit 18, the maximum speed for the predetermined turning radius in the traveling control of the autonomous traveling is a fourth speed lower than the third speed.

A selection of a traveling route also differs depending on the difference in the height in the vertical direction of the outline of the cabin unit 18. For example, the cabin unit (second body) 18 includes at least the third type of second body and the fourth type of second body. The height in the vertical direction of the outline of the third type of second body is the first length, and the height in the vertical direction of the outline of the fourth type of second body is the second length larger than the first length. When the third type of second body is mounted on the cabin unit 18, a traveling route in the traveling control of the autonomous traveling is a first route. When the fourth type of second body is mounted on the cabin unit 18, the traveling route in the traveling control of the autonomous traveling is a second route in which a height limitation in the route is less strict than that of the first route.

The selection of the traveling route also differs depending on a difference in an allowable inclination degree of the cabin unit 18. For example, the cabin unit (second body) 18 includes at least a seventh type of second body and an eighth type of second body. An allowable inclination degree of the seventh type of second body is a first inclination degree, and an allowable inclination degree of the eighth type of second body is a second inclination degree smaller than the first inclination degree. When the seventh type of second body is mounted on the cabin unit 18, the traveling route in the traveling control of the autonomous traveling is a third route. When the eighth type of second body is mounted on the cabin unit 18, the traveling route in the traveling control of the autonomous traveling is a fourth route in which a maximum inclination degree in the route is smaller than that of the third route.

As described above, according to the vehicle 16 that constitutes the moving body management system 15 of the second embodiment, the vehicle can autonomously travel by the steered wheels 170F and the driven wheels 170R. The vehicle 16 includes the self-propelled carriage unit 17 including the autonomous driving ECU 178 that acquires the attribute information of the cabin unit 18, and the cabin unit 18 attachable to and detachable from the self-propelled carriage unit 17. When the cabin unit 18 is mounted on the self-propelled carriage unit 17, the self-propelled carriage unit 17 switches the traveling control of the autonomous traveling based on the cabin unit mounting information including at least one of the mass of the cabin unit 18, the height in the vertical direction of the outline of the cabin unit, the center-of-gravity position of the cabin unit 18, the attribute of the load object that is put in the cabin unit 18, the acceleration request level of the cabin unit 18, and the allowable inclination degree of the cabin unit 18. Therefore, when an infant, a toddler, or an elderly person is placed in the cabin unit 18, it is possible to change traveling conditions such as acceleration during acceleration and deceleration and acceleration during turning in which riding comfort is emphasized to perform safe traveling without causing motion sickness, and when the cabin unit 18 carries a fragile object or an object weak to vibration as a cargo, not only acceleration is changed to acceleration for carrying safely, but also the cargo can be carried safely while avoiding a rough road with large vibration, a steep slope, or a traffic jam.

([1] of Third Embodiment)

Next, a moving body management system of [1] of a third embodiment will be described.

The moving body management system of [1] of the third embodiment includes a vehicle and a management server, similar to the moving body management systems 1 and 15 of the first and second embodiments described above. A reference numeral 25 is assigned to the moving body management system of [1] of the third embodiment, and a reference numeral 26 is assigned to the vehicle that constitutes the moving body management system 25. The vehicle 26 is a moving body that operates autonomously.

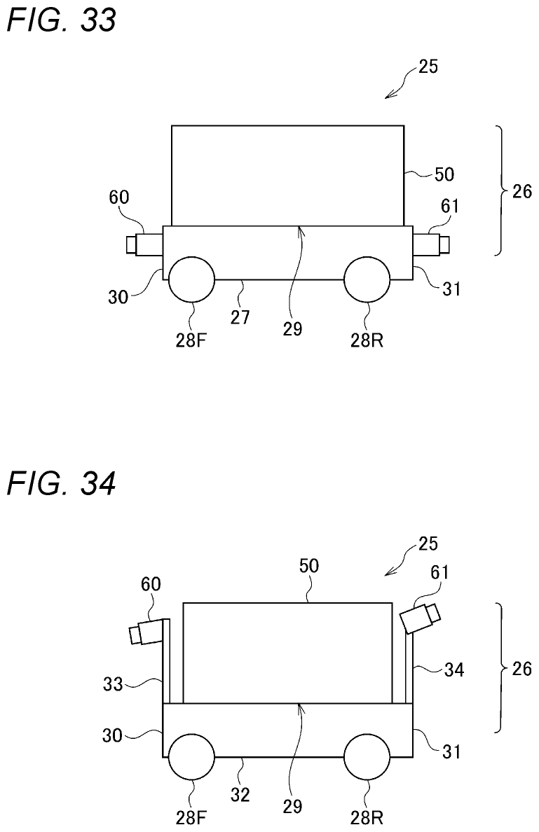

FIG. 33 is a side view showing an external appearance of the vehicle 26 of the moving body management system 25 of [1] of the third embodiment. As shown in FIG. 33, the vehicle 26 includes a self-propelled carriage unit (first body) 27, and a cabin unit (second body) 50 attachable to and detachable from the self-propelled carriage unit 27. The vehicle 26 can travel in a predetermined traveling direction. Here, the predetermined traveling direction is a predetermined traveling direction when the vehicle 26 is switched to “travel forward” and “travel backward”.

The self-propelled carriage unit 27 has a rectangular box shape, includes two front wheels 28F (only one of the two front wheels 28F is shown in FIG. 33) and two rear wheels 28R (only one of the two rear wheels 28R is shown in FIG. 33), and travels on ground by the two front wheels 28F and the two rear wheels 28R. The two front wheels 28F are steered wheels, and the rear wheels 28R are driven wheels. Incidentally, the front wheel is a wheel on a front side when a vehicle travels forward, and the rear wheel is a wheel on a side opposite to the front wheel. Instead of using the front wheels 28F as the steered wheels and the rear wheels 28R as the driven wheels, the steered wheels may also serve as the driven wheels (a drive system referred to as so-called FF). Further, the self-propelled carriage unit 27 is a four-wheeled vehicle including the four wheels 28F and 28R, but may be a single-wheeled vehicle including one wheel. That is, at least one wheel may be provided.

The self-propelled carriage unit 27 may not move by the wheels 28F and 28R, but may include a propeller and can move while floating in air by the propeller (for example, a drone).

The self-propelled carriage unit 27 includes a support surface 29 that can support at least a part of the cabin unit 50. The self-propelled carriage unit 27 includes two sensor circuits 60 and 61 each of which acquires information on an outside of the self-propelled carriage unit 27. The sensor circuit 60 is directed to an outside of the self-propelled carriage unit 27, and at least a part of the sensor circuit 60 is disposed below the support surface 29 of the self-propelled carriage unit 27 in a vertical direction at an end portion 30 in a forward-traveling direction. The sensor circuit 61 is directed to an outside of the self-propelled carriage unit 27, and at least a part of the sensor circuit 61 is disposed below the support surface 29 of the self-propelled carriage unit 27 in the vertical direction at an end portion 31 in a direction opposite to the forward-traveling direction.

Each of the sensor circuits 60 and 61 includes sensors such as a camera including an image-capturing element, a microphone, and a Lidar (Lidar: light detection and ranging). Video information is obtained by the cameras of the sensor circuits 60 and 61, sound information is obtained by the microphones, and distance information is obtained by the Lidars. It is not necessary to include all of the camera, the microphone, and the Lidar, and at least one of them may be provided. Further, the microphone also includes an ultrasonic sensor. The self-propelled carriage unit 27 autonomously operates based on information acquired by the sensor circuits 60 and 61.

The cabin unit 50 has a rectangular box shape (in the drawing, since the drawing is seen in a plan view, the cabin unit 50 cannot be seen in the box shape, but actually, the cabin unit 50 has the box shape) in which a length in the vertical direction is longer than a length of the self-propelled carriage unit 27 in the vertical direction (that is, a height), and a length in a horizontal direction (that is, a length corresponding to a traveling direction of the vehicle 26) is slightly shorter than a length of the self-propelled carriage unit 27 in a horizontal direction (that is, the length corresponding to the traveling direction of the vehicle 26). When the cabin unit 50 is mounted on the self-propelled carriage unit 27, at least a part of the cabin unit 50 is disposed above the self-propelled carriage unit 27 with respect to the length in the vertical direction (that is, the height). For example, when a person is placed in the cabin unit 50, the cabin unit 50 includes a occupant's region reserved for an occupant therein, and a seat on which the occupant can sit is disposed in the occupant's region. For example, a part of the cabin unit 50 may protrude, and may be located below the self-propelled carriage unit 27.

The shape of the self-propelled carriage unit 27 and the shape of the cabin unit 50 are not limited to the shapes shown in FIG. 33, and various shapes may be considered. Further, attachment positions of the sensor circuits 60 and 61 are not limited to the positions shown in FIG. 33, and various positions may be considered. Examples thereof will be described.

FIG. 34 is a side view showing an external appearance of a modified example [1] of the self-propelled carriage unit 27 of the vehicle 26. As shown in FIG. 34, the self-propelled carriage unit 32, which is the modified example [1] of the self-propelled carriage unit 27, includes the support surface 29 that can support the cabin unit 50, and includes protruding parts 33 and 34 that protrude upward (in a vertical direction) with respect to the support surface 29 at both end portions of the end portion 30 in a forward-traveling direction and the end portion 31 in a direction opposite to the forward-traveling direction. In this case, the protruding part 33 is provided on an end portion 30 side in the forward-traveling direction, and the protruding part 34 is provided on an end portion 31 side in the direction opposite to the forward-traveling direction. At least a part of the sensor circuit 60 is disposed above the support surface 29 of the self-propelled carriage unit 27 in the vertical direction at a distal end portion of the protruding part 33. At least a part of the sensor circuit 61 is disposed above the support surface 29 of the self-propelled carriage unit 27 in the vertical direction at a distal end portion of the protruding part 34. Since the protruding parts 33 and 34 are provided and the sensor circuits 60 and 61 are moved to high positions, a monitoring range can be expanded as compared with a case where the sensor circuits 60 and 61 are provided at the end portions 30 and 31 of the self-propelled carriage unit 27 shown in FIG. 33.

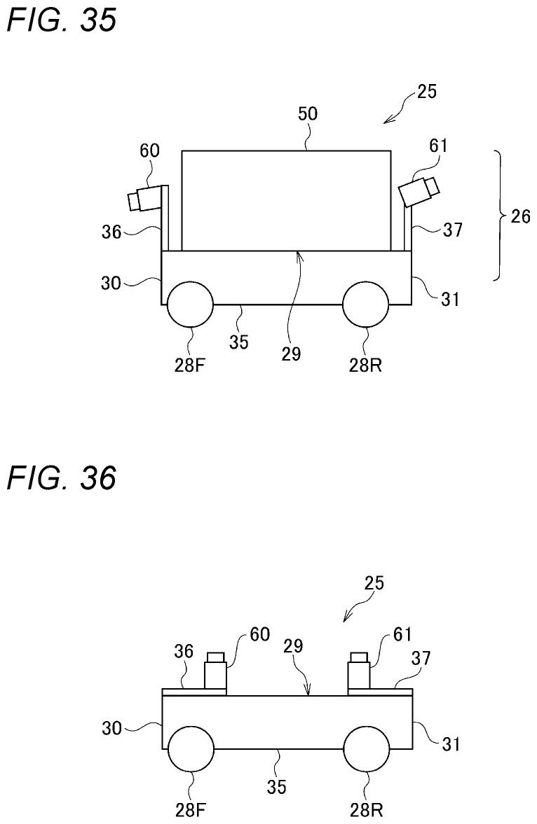

FIG. 35 is a side view showing an external appearance of a modified example [2] of the self-propelled carriage unit 27 of the vehicle 26. As shown in FIG. 35, a self-propelled carriage unit 35, which is the modified example [2] of the self-propelled carriage unit 27, includes protruding parts 36 and 37 that are shorter than the protruding parts 33 and 34 of the self-propelled carriage unit 32 shown in FIG. 34 and are foldable inward. The sensor circuit 60 is disposed at a distal end portion of the protruding part 36, and the sensor circuit 61 is disposed at a distal end portion of the protruding part 37.

FIG. 36 is a side view showing a state where the protruding parts 36 and 37 of the self-propelled carriage unit 35 are folded. Since the foldable protruding parts 36 and 37 are provided, when the sensor circuits 60 and 61 are not used, both the sensor circuits 60 and 61 can be tilted inward with respect to the self-propelled carriage unit 35, and the sensor circuits 60 and 61 can be protected, for example, by avoiding an impact from an outside. Instead of being able to fold the protruding parts 36 and 37, the protruding parts 36 and 37 may be extended and collapsed in an upper-lower direction. In this case, it is needless to say that both the sensor circuits 60 and 61 can be extended and collapsed.

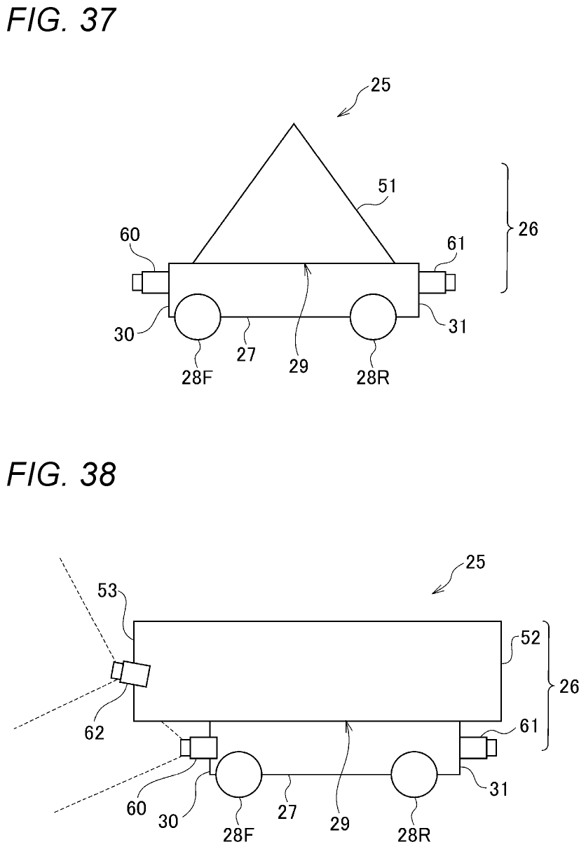

FIG. 37 is a side view showing an external appearance of a modified example [1] of the cabin unit 50 of the vehicle 26. As shown in FIG. 37, a cabin unit 51 of the modified example [1] has a triangular shape in a plan view. In FIG. 37, the cabin unit 51 is mounted on the self-propelled carriage unit 27, but it is needless to say that the cabin unit 51 may be mounted on the self-propelled carriage units 32 and 35 of the modified examples [1] and [2] of the self-propelled carriage unit 27 described above.

FIG. 38 is a side view showing an external appearance of a modified example [2] of the cabin unit 50 of the vehicle 26. As shown in FIG. 38, a cabin unit 52 of the modified example [2] is larger than the self-propelled carriage unit 27 in a plan view. That is, the cabin unit 52 has a rectangular shape that is larger than the self-propelled carriage unit 27 and that protrudes forward and backward in a horizontal direction (although the cabin unit 52 can be seen only in the rectangular shape because the cabin unit 52 is seen in a plan view in the drawing, the cabin unit 52 actually has a box shape). In the cabin unit 52, a sensor circuit 62 is disposed at an end portion 53 on a forward-traveling direction side so as to be directed to an outside of the self-propelled carriage unit 27. The sensor circuit 62 protrudes from the sensor circuit 60 in a horizontal direction. The sensor circuit 62 has the same configuration as those of the sensor circuits 60 and 61 described above.

When the cabin unit 52, which is larger than the self-propelled carriage unit 27 and protrudes forward and backward in the horizontal direction, is mounted on the self-propelled carriage unit 27, the sensor circuits 60 and 61 arranged on the self-propelled carriage unit 27 may be hidden behind protruding portions of the cabin unit 52. In this case, an unmonitorable region may be generated in each of the sensor circuits 60 and 61. In FIG. 38, the sensor circuit 60 disposed at the end portion 30 of the self-propelled carriage unit 27 in a forward-traveling direction is hidden behind the front protruding portion of the cabin unit 52. In such a case, by using the sensor circuit 62 disposed on the cabin unit 52, it is possible to compensate for the unmonitorable region of the sensor circuit 60 disposed on the self-propelled carriage unit 27.

Next, an electrical configuration of the self-propelled carriage unit 27 and an electrical configuration of the cabin unit 50 will be described. Since electrical configurations of the self-propelled carriage units 32 and 35 are the same as that of the self-propelled carriage unit 27, description thereof will be omitted. Further, since the cabin unit 51 is also the same as the cabin unit 50, description thereof will be omitted.

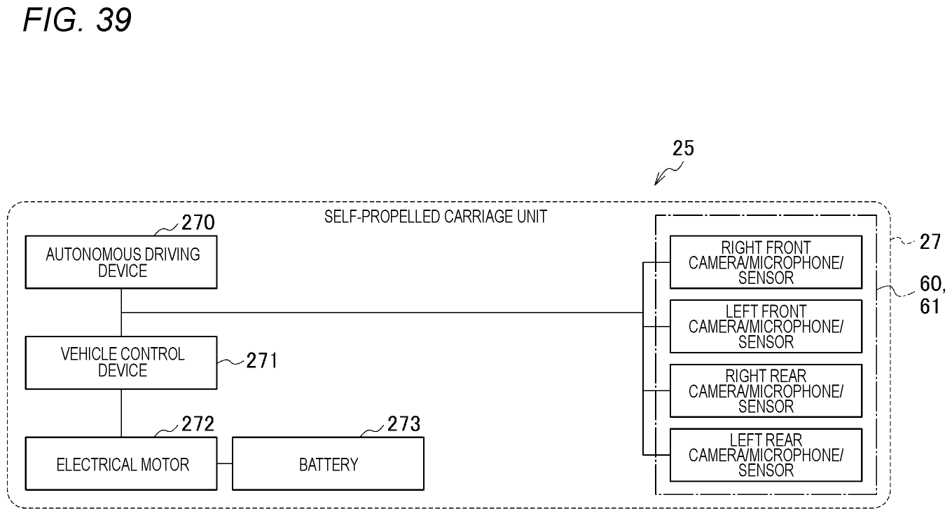

FIG. 39 is a block diagram showing the electrical configuration of the self-propelled carriage unit 27 of the vehicle 26. As shown in FIG. 39, the self-propelled carriage unit 27 includes the sensor circuits 60 and 61 described above, an autonomous driving device 270, a vehicle control device 271, an electrical motor 272, and a battery 273. The sensor circuit 60 is disposed at the end portion 30 of the self-propelled carriage unit 27 in the forward-traveling direction, and the sensor circuit 61 is disposed at the end portion 31 in the direction opposite to the forward-traveling direction. Each of the sensor circuits 60 and 61 is configured with two sets of left and right cameras, microphones, and sensors. That is, the sensor circuit 60 is configured with a right front camera/microphone/sensor and a left front camera/microphone/sensor, and the sensor circuit 61 is configured with a right rear camera/microphone/sensor and a left rear camera/microphone/sensor.

Information output from each of the sensor circuits 60 and 61 is taken into the autonomous driving device 270. The autonomous driving device 270 generates information for autonomous traveling of the self-propelled carriage unit 27 by using the information of each of the sensor circuits 60 and 61 and the like, and outputs the generated information to the vehicle control device 271. The autonomous driving device 270 includes a CPU, a ROM that stores a program for controlling the CPU, and a RAM used for an operation of the CPU (not shown). The vehicle control device 271 controls the electrical motor (electric motor) 272 and the like in accordance with the information for autonomous traveling acquired from the autonomous driving device 270. The electrical motor 272 provides a drive force to the two driven wheels 28R that are driven wheels of the self-propelled carriage unit 27. Electric power output from the battery 273 is supplied to the electrical motor 272. The self-propelled carriage unit 27 of the present embodiment also includes a steering control unit for steering, and the steering control unit performs control to change the wheel angle of the two front wheels 28F that are the steered wheels of the self-propelled carriage unit 27. The vehicle control device 271 includes a CPU, a ROM that stores a program for controlling the CPU, and a RAM used for an operation of the CPU (not shown).

In this way, in the vehicle 26 of the moving body management system 25 of [1] of the third embodiment, the sensor circuits 60 and 61 are provided only on a self-propelled carriage unit 27 side, so that behavior of the self-propelled carriage unit 27 can be monitored regardless of presence or absence of the cabin unit 50. Further, since it is not necessary to provide the sensor circuits 60 and 61 on a cabin unit 50 side where the number of the sensor circuits 60 and 61 is larger than the number of the self-propelled carriage units 27, an installation cost of the sensor circuits 60 and 61 can be reduced, and a degree of freedom in designing the cabin unit 50 can be increased.

([2] of Third Embodiment)

Next, a moving body management system of [2] of the third embodiment will be described.

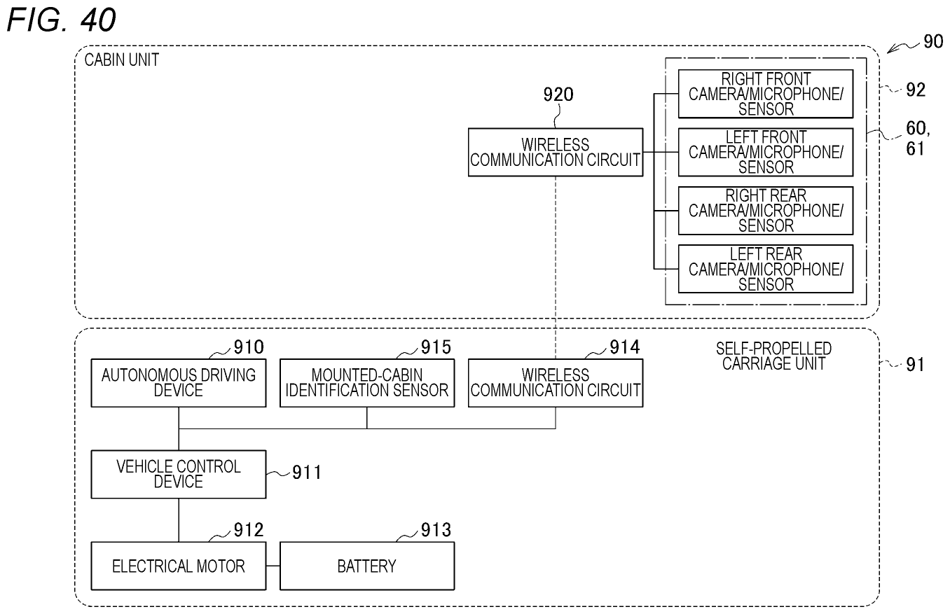

In the moving body management system 25 of [2] of the third embodiment, the sensor circuits 60 and 61 are provided only on a cabin unit 50 side. FIG. 40 is a block diagram showing an electrical configuration of each of the self-propelled carriage unit 27 and the cabin unit 50. Here, a reference numeral 90 is assigned to a vehicle that constitutes the moving body management system 25 of [2] of the third embodiment. Further, a reference numeral 91 is assigned to the self-propelled carriage unit that constitutes the vehicle 90, and a reference numeral 92 is assigned to the cabin unit.

In FIG. 40, the same reference numerals are assigned to parts common to those in FIG. 39 described above. As shown in FIG. 40, the self-propelled carriage unit 91 includes an autonomous driving device 910, a vehicle control device 911, an electrical motor 912, a battery 913, a wireless communication circuit 914, and a mounted-cabin identification sensor 915. The wireless communication circuit 914 performs wireless communication with a wireless communication circuit 920 of the cabin unit 92, and receives information of the sensor circuits 60 and 61 transmitted from the wireless communication circuit 920. The mounted-cabin identification sensor 915 identifies the cabin unit 92 mounted on the self-propelled carriage unit 91. The autonomous driving device 910 generates information for autonomous traveling of the self-propelled carriage unit 91 based on information from the sensor circuits 60 and 61 of the cabin unit 92 and an identification result by the mounted-cabin identification sensor 915, and outputs the generated information to the vehicle control device 911. The vehicle control device 911 performs control of the electrical motor 912 and steering control based on the information for autonomous traveling from the autonomous driving device 910.

The cabin unit 92 includes the sensor circuits 60 and 61 and the wireless communication circuit 920. The wireless communication circuit 920 performs wireless communication with a wireless communication circuit 914 of the self-propelled carriage unit 91, and transmits information from the sensor circuits 60 and 61.

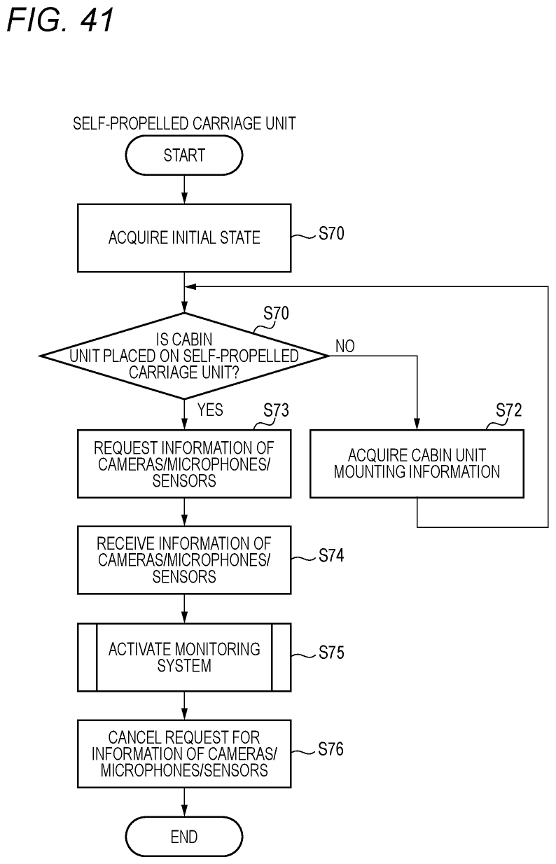

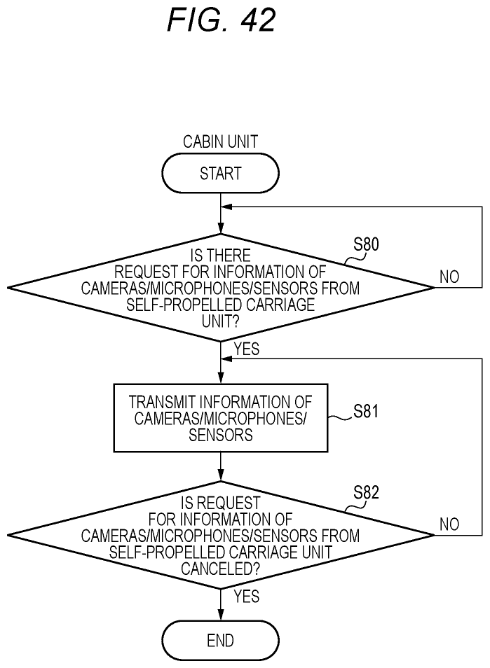

FIG. 41 is a flowchart for illustrating an operation of the self-propelled carriage unit 91 of the vehicle 90 in the moving body management system 25 of [2] of the third embodiment. Further, FIG. 42 is a flowchart for illustrating an operation of the cabin unit 92 of the vehicle 90 in the moving body management system 25 of [2] of the third embodiment. In FIG. 41, when starting an operation, the autonomous driving device 910 first acquires an initial state (step S70). The initial state includes a state of the cabin unit 92 (placed (mounted)/not placed (not mounted) on the self-propelled carriage unit 91). After acquiring the initial state, the autonomous driving device 910 determines whether the cabin unit 92 is placed on the self-propelled carriage unit 91 (that is, whether the cabin unit 92 is mounted) (step S71). When determining that the cabin unit 92 is not placed on the self-propelled carriage unit 91 (when determining as “No” in step S71), the autonomous driving device 910 acquires the cabin unit mounting information (step S72), and returns to the processing of step S71. That is, when determining that the cabin unit 92 is not placed on the self-propelled carriage unit 91, the autonomous driving device 910 repeats the acquisition of the cabin unit mounting information until it is determined that the cabin unit 92 is placed on the self-propelled carriage unit 91.

When determining that the cabin unit 92 is placed on the self-propelled carriage unit 91 (when determining as “Yes” in step S71), the autonomous driving device 910 requests information of the sensor circuits 60 and 61 from the cabin unit 92 (step S73). Here, transmission and reception of the information of the sensor circuits 60 and 61 is performed between the wireless communication circuit 914 of the self-propelled carriage unit 91 and the wireless communication circuit 920 of the cabin unit 92. After requesting the information of the sensor circuits 60 and 61, the autonomous driving device 910 receives the information (step S74). Next, the autonomous driving device 910 activates a monitoring system as a subroutine (step S75). Thereafter, the request for the information of the sensor circuits 60 and 61 is canceled (step S76), and the present processing is ended. The monitoring system is implemented by the autonomous driving device 910, and details of the processing will be described later.

In contrast, in FIG. 42, when starting the operation, the wireless communication circuit 920 determines whether there is the request for the information of the sensor circuits 60 and 61 from the self-propelled carriage unit 91 (step S80). When determining that there is no request (when determining as “No” in step S80), the wireless communication circuit 920 repeats the present processing until it is determined that there is the request. When determining that there is the request for the information of the sensor circuits 60 and 61 (when determining as “Yes” in step S80), the wireless communication circuit 920 transmits the information of the sensor circuits 60 and 61 (step S81). Thereafter, the wireless communication circuit 920 determines whether the request for the information of the sensor circuits 60 and 61 from the self-propelled carriage unit 91 is canceled (step S82). When determining that the request is not canceled (when determining as “No” in step S82), the wireless communication circuit 920 returns to step S81, and continues the transmission of the information of the sensor circuits 60 and 61 until the request for the information of the sensor circuits 60 and 61 is canceled. When determining that the request for the information of the sensor circuits 60 and 61 from the self-propelled carriage unit 91 is canceled (when determining as “Yes” in step S82), the wireless communication circuit 920 ends the present processing.

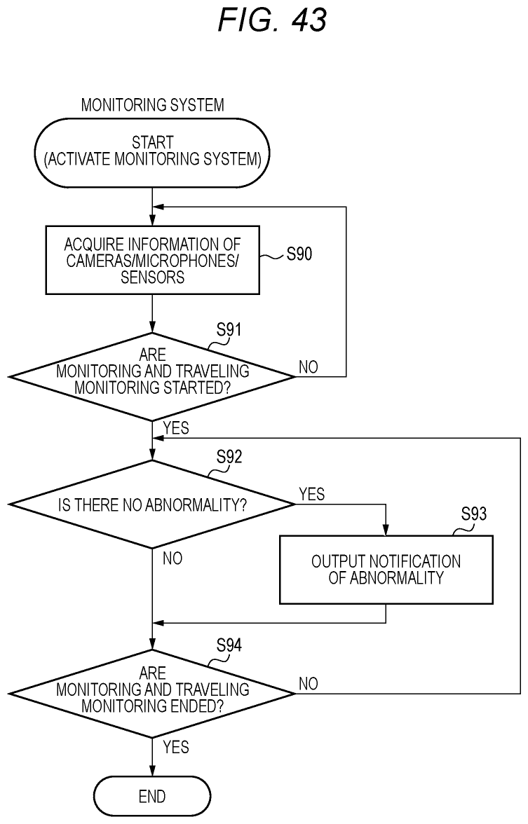

FIG. 43 is a flowchart for illustrating an operation of the autonomous driving device 910 as the monitoring system. In FIG. 43, the autonomous driving device 910 acquires information of the sensor circuits 60 and 61 of the cabin unit 92 (step S90). Next, it is determined whether to start monitoring and traveling monitoring (step S91). Here, the “monitoring” is monitoring for checking inside and outside of the vehicle when the vehicle 90, which is a vehicle, stops. For example, when the cabin unit 92 is a passenger car that conveys a person, monitoring is performed such as monitoring a periphery of a door after the cabin unit 92 stops. Further, the “traveling monitoring” is monitoring of a vehicle traveling direction and the like related to traveling. Further, the vehicle control device 911 determines the start of the monitoring and the traveling monitoring, but the monitoring and the traveling monitoring may be started in accordance with a preset schedule.

When it is determined not to start the monitoring and the traveling monitoring (when it is determined as “No” in step S91), the autonomous driving device 910 returns to step S90 and continues to acquire the information of the sensor circuits 60 and 61. When it is determined to start the monitoring and the traveling monitoring (when it is determined as “Yes” in step S91), the autonomous driving device 910 starts the monitoring and the traveling monitoring based on the information of the sensor circuits 60 and 61. Then, it is determined whether there is no abnormality in the monitoring and the traveling monitoring (step S92). When it is determined that there is an abnormality (when it is determined as “Yes” in step S92), the vehicle control device 911 is notified of the abnormality (step S93).

When starting the monitoring and the traveling monitoring and determining that there is no abnormality (when determining as “No” in step S92), the autonomous driving device 910 determines whether to end the monitoring and the traveling monitoring (step S94). When determining not to end the monitoring and the traveling monitoring (when determining as “No” in step S94), the autonomous driving device 910 returns to step S92 and continues the determination of whether there is no abnormality. When determining to end the monitoring and the traveling monitoring (when determining as “Yes” in step S94), the autonomous driving device 910 ends the present processing. Further, the vehicle control device 911 determines the end of the monitoring and the traveling monitoring, but the monitoring and the traveling monitoring may be ended in accordance with a preset schedule.

In this way, in the vehicle 90 of the moving body management system 25 of [2] of the third embodiment, the sensor circuits 60 and 61 are provided only on a cabin unit 92 side, and therefore, in a case of a vehicle having a separation structure in which vehicle heights when the cabin unit 92 is mounted and when the cabin unit 92 is not mounted are equal to each other, in addition to the function of the traveling monitoring, the vehicle 90 can be used for applications other than the traveling monitoring, such as door opening and closing monitoring and cabin unit internal monitoring.

Since positions of the sensor circuits 60 and 61 can be adjusted for each size of the cabin unit 92, a degree of freedom in designing the cabin unit 92 can be increased.

A degree of freedom in designing the self-propelled carriage unit 91 can be increased. A plurality of self-propelled carriage units 91 can be monitored by the sensor circuits 60 and 61 installed on the cabin unit 92, so that an installation cost can be reduced.

([3] of Third Embodiment)

Next, a moving body management system of [3] of the third embodiment will be described.

In the moving body management system 25 of [3] of the third embodiment, the sensor circuits 60 and 61 are provided on both the self-propelled carriage unit and the cabin unit. The sensor circuit on a self-propelled carriage unit side acquires at least information on an outside of the self-propelled carriage unit, and the sensor circuit on a cabin unit side acquires at least information on an outside of the cabin unit.

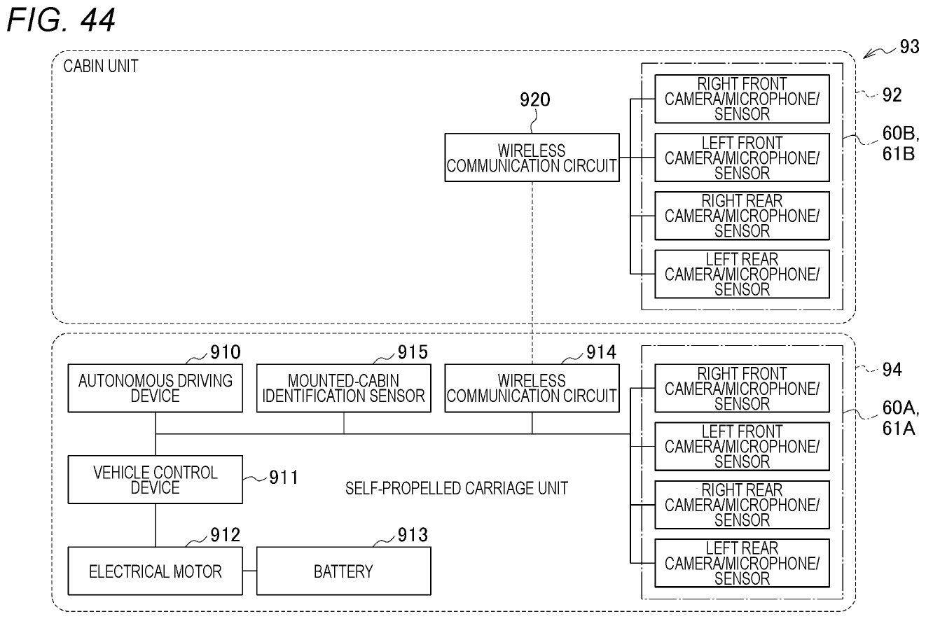

FIG. 44 is a block diagram showing an electrical configuration of each of a self-propelled carriage unit 94 and the cabin unit 92. Here, a reference numeral 93 is assigned to a vehicle that constitutes the moving body management system 25 of [3] of the third embodiment. Further, a reference numeral 94 is assigned to the self-propelled carriage unit that constitutes the vehicle 93, and a reference numeral 92 the same as that of the cabin unit in FIG. 40 is assigned to the cabin unit. Further, reference numerals 60A and 61A are assigned to sensor circuits on a self-propelled carriage unit 94 side, and reference numerals 60B and 61B are assigned to sensor circuits on a cabin unit 92 side. The sensor circuits 60A and 61A on the self-propelled carriage unit 94 side correspond to a first sensor circuit, and the sensor circuits 60B and 61B on the cabin unit 92 side correspond to a second sensor circuit. Since configurations of the self-propelled carriage unit 94 and the cabin unit 92 are as described above, description thereof will be omitted here.

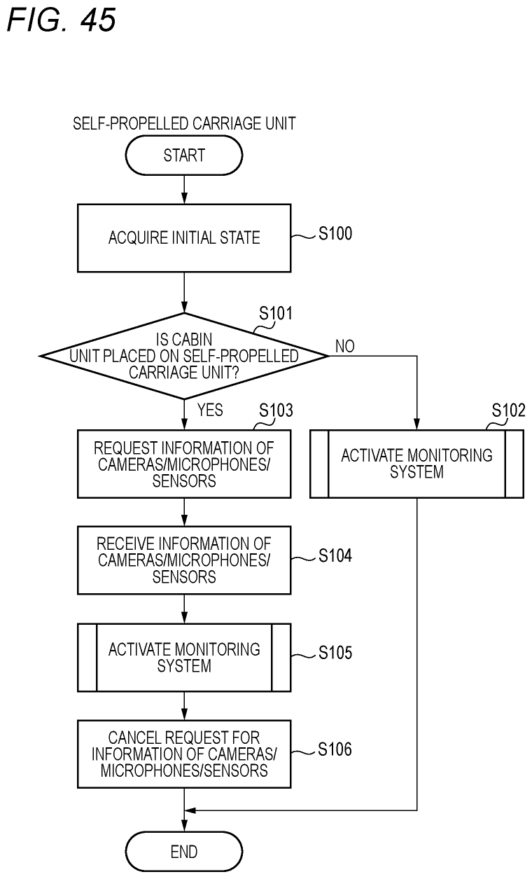

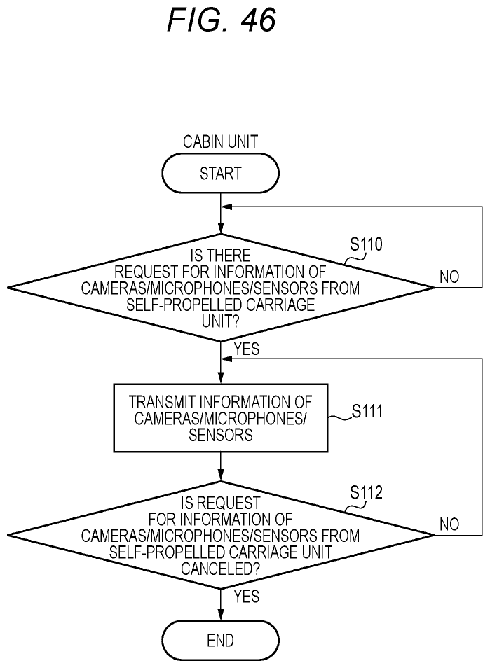

FIG. 45 is a flowchart for illustrating an operation of the self-propelled carriage unit 94 of the vehicle 93 in the moving body management system 25 of [3] of the third embodiment. Further, FIG. 46 is a flowchart for illustrating an operation of the cabin unit 92 of the vehicle 93 in the moving body management system 25 of [3] of the third embodiment. In FIG. 45, when starting an operation, the autonomous driving device 910 first acquires an initial state (step S100). Next, the autonomous driving device 910 determines whether the cabin unit 92 is placed on the self-propelled carriage unit 94 (that is, whether the cabin unit 92 is mounted on the self-propelled carriage unit 94) (step S101). When determining that the cabin unit 92 is not placed on the self-propelled carriage unit 94 (when determining as “No” in step S101), the autonomous driving device 910 activates a monitoring system (step S102). When activating the monitoring system, the autonomous driving device 910 performs monitoring based on information from the sensor circuits 60A and 61A of the self-propelled carriage unit 94. After activating the monitoring system, the autonomous driving device 910 ends the present processing. When determining that the cabin unit 92 is placed on the self-propelled carriage unit 94 (when determining as “Yes” in step S101), the autonomous driving device 910 requests information from the sensor circuits 60B and 61B of the cabin unit 92 (step S103). When the information of the sensor circuits 60B and 61B is transmitted from the cabin unit 92, the information is received (step S104).

Next, the autonomous driving device 910 activates the monitoring system (step S105). The monitoring system performs monitoring based on the information from the sensor circuits 60B and 61B of the cabin unit 92. After activating the monitoring system, the autonomous driving device 910 cancels the information request of the sensor circuits 60B and 61B to the cabin unit 92 (step S106), and ends the present processing.

In contrast, in FIG. 46, the wireless communication circuit 920 determines whether there is the request for the information of the sensor circuits 60B and 61B from the self-propelled carriage unit 94 (step S110). When determining that there is no request (when determining as “No” in step S110), the wireless communication circuit 920 repeats the determination until there is a request for the information. When determining that there is the request for the information of the sensor circuits 60B and 61B (when determining as “Yes” in step S110), the wireless communication circuit 920 transmits the information from the sensor circuits 60B and 61B (step S111). After the transmission of the information, the wireless communication circuit 920 determines whether the self-propelled carriage unit 94 cancels the request for the information of the sensor circuits 60B and 61B (step S112). When determining that the request for the information is not canceled (when determining as “No” in step S112), the wireless communication circuit 920 returns to step S111, and continues the transmission of the information from the sensor circuits 60B and 61B. When determining that the request for the information of the sensor circuits 60B and 61B is canceled (when determining as “Yes” in step S112), the wireless communication circuit 920 ends the present processing.

In the moving body management system 25 of [3] of the third embodiment, when the cabin unit 92 is not placed on the self-propelled carriage unit 94, only the information from the sensor circuits 60A and 61A of the self-propelled carriage unit 94 is acquired, and when the cabin unit 92 is placed on the self-propelled carriage unit 94, only the information from the sensor circuits 60B and 61B of the cabin unit 92 is acquired. However, both the information from the sensor circuits 60A and 61A and the information from the sensor circuits 60B and 61B may be acquired simultaneously. That is, the following may be performed.

(1) The sensor circuits 60A and 61A acquire the information on the outside of the self-propelled carriage unit 94, and the sensor circuits 60B and 61B do not acquire the information on the outside of the cabin unit 92.

(2) The sensor circuits 60A and 61A do not acquire the information on the outside of the self-propelled carriage unit 94, and the sensor circuits 60B and 61B acquire the information on the outside of the cabin unit 92.

(3) The sensor circuits 60A and 61A acquire the information on the outside of the self-propelled carriage unit 94, and the sensor circuits 60B and 61B acquire the information on the outside of the cabin unit 92 simultaneously.

In this way, in the vehicle 93 of the moving body management system 25 of [3] of the third embodiment, the sensor circuits 60A and 61A necessary when the cabin unit 92 is not mounted are mounted on the self-propelled carriage unit 94 side, and the sensor circuits 60B and 61B necessary when the cabin unit 92 is mounted are mounted on the cabin unit 92 side, so that even when the cabin unit 52 having a large size, structure, or the like is placed on the self-propelled carriage unit 94 as shown in FIG. 38, monitoring can be performed without generating an unmonitorable region. That is, when the cabin unit 52 that is larger than the self-propelled carriage unit 94 and that protrudes forward and backward in the horizontal direction is mounted on the self-propelled carriage unit 94, even when the sensor circuits 60A and 61A on the self-propelled carriage unit 94 side are hidden behind the protruding portions of the cabin unit 52, unmonitorable regions of the sensor circuits 60A and 61A can be compensated by the sensor circuits 60B and 61B on a cabin unit 52 side.

While the present invention has been described in detail with respect to specific embodiments, it will be apparent to those skilled in the art that various changes and modifications can be made without departing from the spirit and scope of the present invention.

The present application is based on Japanese Patent Application (Japanese Patent Application No. 2019-206879, Japanese Patent Application No. 2019-206880, and Japanese Patent Application No. 2019-206881) filed on Nov. 15, 2019, and the contents of which are incorporated herein by reference.

The present application also discloses a moving body and a traveling control switching control method for autonomous traveling of the moving body described in [A-1] to [A-10] below.

[A-1] A moving body including:

a first body including at least one steered wheel and at least one driven wheel, the first body being configured to autonomously travel by the steered wheel and the driven wheel; and

a second body attachable to and detachable from the first body,

wherein the first body includes an attribute information acquisition circuit configured to acquire attribute information of the second body,

wherein when the second body is mounted on the first body, the first body switches traveling control of autonomous traveling based on the attribute information of the second body, and

wherein the attribute information of the second body includes at least one of:

a mass of the second body,

a height in a vertical direction of an outline of the second body,

a center-of-gravity position of the second body,

an attribute of a load object that is put in the second body,

an acceleration request level of the second body, and

an allowable inclination degree of the second body.

[A-2] The moving body according to [A-1],

wherein the steered wheel and the driven wheel are the same.

[A-3] The moving body according to [A-1] or [A-2],

wherein the second body includes an attribute information holding unit configured to hold the attribute information of the second body, and

wherein the attribute information acquisition circuit of the first body is configured to acquire the attribute information held by the attribute information holding unit of the second body.

[A-4] The moving body according to [A-1] or [A-2],

wherein the second body includes an identification information holding unit configured to hold identification information of the second body,

wherein the first body includes a wireless communication circuit configured to communicate with an external server, and

wherein when the second body is mounted on the first body, the attribute information acquisition circuit acquires the identification information held by the identification information holding unit of the second body, and acquires the attribute information corresponding to the identification information via the wireless communication circuit.

[A-5] The moving body according to any one of [A-1] to [A-4],

wherein the second body includes at least a first type of second body and a second type of second body,

wherein a mass of the first type of second body is a first weight,

wherein a mass of the second type of second body is a second weight larger than the first weight,

wherein when the first type of second body is mounted on the first body, a maximum speed for a predetermined turning radius in the traveling control of the autonomous traveling is a first speed, and

wherein when the second type of second body is mounted on the first body, a maximum speed for the predetermined turning radius in the traveling control of the autonomous traveling is a second speed lower than the first speed.

[A-6] The moving body according to any one of [A-1] to [A-5],

wherein the second body includes at least a third type of second body and a fourth type of second body,

wherein a height in a vertical direction of an outline of the third type of second body is a first length,

wherein a height in a vertical direction of an outline of the fourth type of second body is a second length larger than the first length,

wherein when the third type of second body is mounted on the first body, a maximum speed for a predetermined turning radius in the traveling control of the autonomous traveling is a third speed, and

wherein when the fourth type of second body is mounted on the first body, a maximum speed for the predetermined turning radius in the traveling control of the autonomous traveling is a fourth speed lower than the third speed.

[A-7] The moving body according to any one of [A-1] to [A-6],

wherein the second body includes at least a fifth type of second body and a sixth type of second body,

wherein a height of a center-of-gravity position of the fifth type of second body is a first height,

wherein a height of a center-of-gravity position of the sixth type of second body is a second height higher than the first height,

wherein when the fifth type of second body is mounted on the first body, a maximum speed for a predetermined turning radius in the traveling control of the autonomous traveling is a fifth speed, and

wherein when the sixth type of second body is mounted on the first body, a maximum speed for the predetermined turning radius in the traveling control of the autonomous traveling is a sixth speed lower than the fifth speed.

[A-8] The moving body according to any one of [A-1] to [A-7],

wherein the second body includes at least a third type of second body and a fourth type of second body,

wherein a height in a vertical direction of an outline of the third type of second body is a first length,

wherein a height in a vertical direction of an outline of the fourth type of second body is a second length larger than the first length,

wherein when the third type of second body is mounted on the first body, a traveling route in the traveling control of the autonomous traveling is a first route, and

wherein when the fourth type of second body is mounted on the first body, a traveling route in the traveling control of the autonomous traveling is a second route in which a height limitation is less strict than that in the first route.

[A-9] The moving body according to any one of [A-1] to [A-8],

wherein the second body includes at least a seventh type of second body and an eighth type of second body,

wherein an allowable inclination degree of the seventh type of second body is a first inclination degree,

wherein an allowable inclination degree of the eighth type of second body is a second inclination degree smaller than the first inclination degree,

wherein when the seventh type of second body is mounted on the first body, a traveling route in the traveling control of the autonomous traveling is a third route, and

wherein when the eighth type of second body is mounted on the first body, a traveling route in the traveling control of the autonomous traveling is a fourth route in which a maximum inclination degree is smaller than that in the third route.

[A-10] A traveling control switching control method for autonomous traveling of a moving body, the traveling control switching control method being usable for the moving body, the moving body including a first body including at least one steered wheel and at least one driven wheel, the first body being configured to autonomously travel by the steered wheel and the driven wheel, and a second body attachable to and detachable from the first body, the traveling control switching control method including:

acquiring attribute information of the second body and switching traveling control of the autonomous traveling based on the attribute information of the second body when the second body is mounted on the first body,

wherein the attribute information of the second body includes at least one of:

a mass of the second body,

a height in a vertical direction of an outline of the second body,

a center-of-gravity position of the second body,

an attribute of a load object that is put in the second body,

an acceleration request level of the second body, and

an allowable inclination degree of the second body.

The present application also discloses a moving body described in [B-1] to [B-17] below.

[B-1] A moving body configured to autonomously operate, the moving body including:

a first body including at least one wheel, the first body being configured to travel by the wheel;

a second body attachable to and detachable from the first body; and

a sensor circuit installed on the first body, the sensor circuit being configured to acquire at least information on an outside of the first body,

wherein the sensor circuit is configured to acquire at least one of video information and sound information.

[B-2] The moving body according to [B-1],

wherein the sensor circuit includes at least an image-capturing element.

[B-3] The moving body according to [B-1] or [B-2],

wherein the sensor circuit includes at least a microphone.

[B-4] The moving body according to any one of [B-1] to [B-3],

wherein the first body is configured to travel on ground by the wheel, and

wherein when the second body is mounted on the first body, at least a part of the second body is disposed above the first body in a vertical direction.

[B-5] The moving body according to any one of [B-1] to [B-4],

wherein the first body includes a support surface configured to support at least a part of the second body, and

wherein at least a part of the sensor circuit is disposed above the support surface in a vertical direction.

[B-6] The moving body according to [B-5],

wherein at least a part of the first body includes a protruding part that protrudes upward in the vertical direction with respect to the support surface, and

wherein at least a part of the sensor circuit is disposed on the protruding part.

[B-7] The moving body according to [B-6],

wherein the protruding part of the first body is foldable.

[B-8] The moving body according to any one of [B-1] to [B-7],

wherein a traveling direction of the moving body includes a predetermined traveling direction,

wherein the sensor circuit is directed to an outside of the first body and is disposed at an end portion in the traveling direction.

[B-9] The moving body according to any one of [B-1] to [B-8],

wherein the moving body autonomously operates based on information acquired by the sensor circuit.

[B-10] The moving body according to any one of [B-1] to [B-9],

wherein at least one of the first body and the second body includes a wireless communication circuit, and

wherein the information acquired by the sensor circuit is transmitted to an outside via the wireless communication circuit.

[B-11] The moving body according to any one of [B-1] to [B-10],

wherein the sensor circuit is a first sensor circuit, and

wherein the second body includes a second sensor circuit configured to acquire at least information on an outside of the second body.

[B-12] The moving body according to [B-11],

wherein the second sensor circuit acquires at least the information on the outside of the second body simultaneously with the first sensor circuit acquiring at least the information on the outside of the first body.

[B-13] The moving body according to [B-11],

wherein the first sensor circuit acquires at least the information on the outside of the first body, and

wherein the second sensor circuit does not acquire at least the information on the outside of the second body.

[B-14] The moving body according to [B-11],

wherein the first sensor circuit does not acquire at least the information on the outside of the first body, and

wherein the second sensor circuit acquires at least the information on the outside of the second body.

[B-15] The moving body according to any one of [B-11] to [B-14],

wherein the second body on which the second sensor circuit is mounted is larger than the first body on which the first sensor circuit is mounted in a plan view.

[B-16] The moving body according to any one of [B-11] to [B-15],

wherein the second sensor circuit mounted on the second body protrudes from the first sensor circuit mounted on the first body in a horizontal direction.

[B-17] The moving body according to any one of [B-1] to [B-16],

wherein the autonomous operation includes autonomous driving.

A moving body management system of the present disclosure is useful for a system that manages a vehicle that can move autonomously such as a motorcycle and an automobile.

What is claimed is:

1. A moving body comprising:
a first body comprising at least one wheel, the first body being configured to travel by the wheel; and
a second body attachable to and detachable from the first body,
wherein the first body comprises an electric motor configured to drive the at least one wheel and a first secondary battery that allows first electric power to be supplied to the electric motor,
wherein the second body comprises a predetermined electric power load and a second secondary battery that allows second electric power to be supplied to the predetermined electric power load, and
wherein when the second body is mounted on the first body, at least one of the second secondary battery and the first secondary battery is allowed to be charged in a charging mode including at least one of a first charging mode and a second charging mode,
wherein in the first charging mode, the second secondary battery is charged using third electric power output from the first secondary battery, and
wherein in the second charging mode, the first secondary battery is charged using fourth electric power output from the second secondary battery.

2. The moving body according to claim 1,
wherein the predetermined electric power load of the second body comprises at least one of:
a first light disposed on an outer side of the second body,
a second light disposed on an inner side of the second body,
an electric compressor disposed in the second body,
an electric fan disposed in the second body,
a first display disposed inside the second body, and
a second display disposed on a side surface outside the second body.

3. The moving body according to claim 1,
wherein when the second body is not mounted on the first body, the second body is configured to be placed on ground.

4. The moving body according to claim 3,
wherein the second body comprises a leg portion.

5. The moving body according to claim 4,
wherein the leg portion has one of a foldable structure and a collapsible structure.

6. The moving body according to claim 1,
wherein when the second body is not mounted on the first body, the second secondary battery of the second body is configured to be charged by electric power from an external power supply.

7. The moving body according to claim 1,
wherein the electric motor is configured to drive the at least one wheel based on the first electric power output from the first secondary battery and the fourth electric power output from the second secondary battery.

8. The moving body according to claim 1,
wherein when the second body is mounted on the first body, when a voltage of the first secondary battery is smaller than a first value, and when a voltage of the second secondary battery is larger than a second value, the first secondary battery is charged using the fourth electric power output from the second secondary battery.

9. The moving body according to claim 1,
wherein when the second body is mounted on the first body, when a voltage of the second secondary battery is smaller than a third value, and when a voltage of the first secondary battery is larger than a fourth value, the second secondary battery is charged using the third electric power output from the first secondary battery.

10. The moving body according to claim 1,
wherein when the second body is mounted on the first body, the first secondary battery is charged using the fourth electric power output from the second secondary battery based on a use schedule of the second body.

11. The moving body according to claim 10,
wherein in a case in which there is no plan to use the second body until the second secondary battery is charged next in the use schedule, the first secondary battery is charged using the fourth electric power output from the second secondary battery.

12. The moving body according to claim 1,
wherein when the second body is mounted on the first body, the second secondary battery is charged using the third electric power output from the first secondary battery based on a movement schedule of the first body.

13. The moving body according to claim 12,
wherein in a case in which a remaining amount of the first secondary battery is larger than a threshold based on a traveling plan until the first secondary battery is charged next in the movement schedule, the second secondary battery is charged using the third electric power output from the first secondary battery.

14. The moving body according to claim 1,
wherein at least one of the first body and the second body comprises a wireless communication circuit, and
wherein at least one of the first secondary battery and the second secondary battery is charged in a charging mode corresponding to an instruction from an outside received by the wireless communication circuit.

15. The moving body according to claim 14,
wherein at least one of the first body and the second body outputs a remaining amount of at least one of the first secondary battery and the second secondary battery to the outside through the wireless communication unit.

16. A battery control method for a moving body, the moving body comprising:
a first body comprising at least one wheel, the first body being configured to travel by the wheel; and
a second body attachable to and detachable from the first body,
wherein the first body comprises an electric motor configured to drive the at least one wheel and a first secondary battery that allows first electric power to be supplied to the electric motor,
wherein the second body comprises a predetermined electric power load and a second secondary battery that allows second electric power to be supplied to the predetermined electric power load,
the battery control method comprising:
charging at least one of the second secondary battery and the first secondary battery in a charging mode when the second body is mounted on the first body, the charging mode including at least one of a first charging mode and a second charging mode,
wherein in the first charging mode, the second secondary battery is charged using third electric power output from the first secondary battery, and
wherein in the second charging mode, the first secondary battery is charged using fourth electric power output from the second secondary battery.

17. A non-transitory computer-readable medium storing instructions that, when executed by one or more processor, cause a computer to perform operations for a moving body, the moving body comprising:
a first body comprising at least one wheel, the first body being configured to travel by the wheel; and
a second body attachable to and detachable from the first body,
wherein the first body comprises an electric motor configured to drive the at least one wheel and a first secondary battery that allows first electric power to be supplied to the electric motor,
wherein the second body comprises a predetermined electric power load and a second secondary battery that allows second electric power to be supplied to the predetermined electric power load,
the operations comprising:
charging at least one of the second secondary battery and the first secondary battery in a charging mode when the second body is mounted on the first body, the charging mode including at least one of a first charging mode and a second charging mode,
wherein in the first charging mode, the second secondary battery is charged using third electric power output from the first secondary battery, and
wherein in the second charging mode, the first secondary battery is charged using fourth electric power output from the second secondary battery.
